(19) United States
(12) Patent Application Publication
(10) Pub. No.: US 2026/0242602 A1
(43) Pub. Date: Aug. 20, 2026

(54) CRACKING RESISTANT ASPHALT BINDERS INCLUDING BLEND OF LOW VISCOSITY VACUUM TOWER BOTTOMS AND BIO-RESINS, AND RELATED METHODS

(71) Applicant: Marathon Petroleum Company LP, Findlay, OH (US)

(72) Inventors: Cristian S. Clopotel, Findlay, OH (US); Anas A. Jamrah, Findlay, OH (US); Lora C. Collins, Findlay, OH (US)

(73) Assignee: Marathon Petroleum Company LP, Findlay, OH (US)

(21) Appl. No.: 19/544,732

(22) Filed: Feb. 19, 2026

Related U.S. Application Data
(60) Provisional application No. 63/760,970, filed on Feb. 20, 2025.
(60) Provisional application No. 63/760,996, filed on Feb. 20, 2025.
(60) Provisional application No. 63/760,991, filed on Feb. 20, 2025.
(60) Provisional application No. 63/896,394, filed on Oct. 9, 2025.
(60) Provisional application No. 63/896,416, filed on Oct. 9, 2025.

(51) Int. Cl. C08L 95/00; C10C 3/00

(52) U.S. Cl. CPC C08L 95/00; C10C 3/005

(57) ABSTRACT

A cracking resistant asphalt binder includes a high viscosity vacuum tower bottoms material having a vacuum viscosity greater than about 50,000 P at about 60° C., greater than about 10.0 weight percent of a low viscosity vacuum tower bottoms material, and a biomaterial comprising greater than about 80.0 weight percent bio-resin. The combination of the low viscosity vacuum tower bottoms material and the biomaterial imparts desirable properties to the cracking resistant asphalt binder. Related cracking resistant asphalt binder and methods are also disclosed.

### CROSS REFERENCE TO RELATED APPLICATIONS

This application claims the benefit of the filing date of U.S. Provisional Patent Application Ser. No. 63/760,970, filed Feb. 20, 2025, for “CRACKING RESISTANT ASPHALT BINDERS INCLUDING HIGH VISCOSITY VACUUM TOWER BOTTOMS MATERIAL AND AT LEAST ONE OF A HEAVY VACUUM GAS OIL OR A BIOMATERIAL, AND RELATED METHODS,” the filing date of U.S. Provisional Patent Application Ser. No. 63/760,991, filed Feb. 20, 2025, for “CRACKING RESISTANT ASPHALT BINDERS INCLUDING BIO-RESINS, AND RELATED METHODS,” the filing date of U.S. Provisional Patent Application Ser. No. 63/760,996, filed Feb. 20, 2025, for “CRACKING RESISTANT ASPHALT BINDERS INCLUDING HARD ASPHALT, AND RELATED METHODS,” the filing date of U.S. Provisional Patent Application Ser. No. 63/896,394, filed Oct. 9, 2025, for “CRACKING RESISTANT ASPHALT BINDERS INCLUDING BLEND OF LOW VISCOSITY VACUUM TOWER BOTTOMS AND BIO-RESINS, AND RELATED METHODS,” and the filing date of U.S. Provisional Patent Application No. 63/896,416, filed Oct. 9, 2025, for “MOISTURE RESISTANT ASPHALT MIXTURES INCLUDING BLEND OF LOW VISCOSITY VACUUM TOWER BOTTOMS, BIOMATERIALS, AND HARD ASPHALT, AND RELATED METHODS,” the entire disclosure of each of which applications is incorporated herein in its entirety by this reference.

### BACKGROUND

Asphalt binder, also known as bitumen, is a sticky, black, and viscous material. Asphalt may be obtained from natural deposits or may be obtained as a product of crude oil refining. Asphalt is a natural constituent of crude oil, which may include, among other things, paraffinic materials, naphthenes, aromatics, and asphaltenes. Generally, the components of different materials in crude oil are separated by distillation into various fractions. After separation, these fractions are further refined into other products such as gasoline, naphtha, lubricating oil, kerosene, diesel oil, and asphalt. Asphalt binder is the heavy constituent of crude petroleum, and typically forms the residue that remains after the oil refining process.

Asphalt binder may be sold and used as a binder to bind mineral aggregates in asphalt concrete. Asphalt concrete, also referred to as blacktop or pavement, is a composite material used to surface roads and parking lots. Conventional asphalt concrete suffers from different types of distress modes, including permanent deformation. For example, asphalt concrete can deform to cause a depression or groove in the driving surface, also known as rutting. Rutting may prevent the designed removal of rainwater from road surfaces, which can lead to pooling of water on the road surfaces. Asphalt cement exhibiting a high degree of stiffness can mitigate against rutting. Solvent deasphalting (SDA) pitch is a hard, brittle material that has also been used to modify asphalt binders to increase resistance to rutting. Increasing the stiffness of the asphalt binder generally negatively affects the low temperature properties of the asphalt binder, such as by causing the asphalt binder to be more susceptible to thermal or fatigue cracking at intermediate and low temperatures (and increasing the low temperature compliance (e.g., increasing the temperature of the low temperature compliance) of the asphalt binder).

Superior Performance Asphalt Pavement (Superpave) Performance Grade (PG) asphalt binder was introduced in the past in an effort to improve asphalt properties. PG asphalt is specified by the American State Association of State Highway and Transportation Officials (AASHTO). AASHTO M320 is a standard specification developed by the AASHTO for performance graded asphalts. The objective of Superpave and performance graded asphalt specifications is to address permanent deformation (e.g., rutting), fatigue cracking, and low temperature thermal cracking. To address these issues, new equipment was introduced to test the properties of the asphalt binders that affect or correlate to performant deformation, fatigue cracking, and/or low temperature thermal cracking. For example, a dynamic shear rheometer (DSR) may be used to characterize asphalt binder properties at high and intermediate temperatures; and a bending beam rheometer (BBR) and direct tension (DT) device may be used to characterize asphalt binder properties at low temperatures.

The asphalt binder may be aged prior to testing to characterize the performance of the asphalt binder responsive to aging. Methods of aging the asphalt binder include rolling thin film oven (RTFO) aging and pressure aging vessel (PAV) aging. Many performance tests are performed on asphalt binders after RTFO aging or PAV aging for 20 hours or 40 hours. G/sin(δ) was introduced to characterize the unaged and RTFO aged asphalts. In addition, G*sin(δ) on asphalt binders aged for 20 hours in a PAV (20-hour PAV-aged asphalt binder) was introduced to characterize the asphalt binder at intermediate temperatures. Stiffness and m-value, measured in the BBR, were introduced to address thermal cracking.

Although significant improvements were noted after introduction of G*sin(δ), there are several shortcomings in the proposed specification, and the current criterion for thermal cracking is not reliable. The National Cooperative Highway Research Program (NCHRP) 09-59 was initiated to find a better parameter that correlates the fatigue properties of the asphalt binder to the fatigue performance of an asphalt blend. To further address thermal cracking, Delta T_{c} (ΔT_{c}) was introduced by the Airfield Asphalt Pavement Technology Program (AAPTP), Project 06-01 “Techniques for Prevention and Remediation of Non-Load-Related Distresses on HMA Airport Pavements.” The ΔT_{c} is an indicator of how effectively the asphalt binder responds to aging. The ΔT_{c} corresponds to the difference in the critical low temperature values of the asphalt binder according to the Superpave performance grading methodology. The ΔT_{c} is calculated by subtracting the BBR S-critical temperature at 60 seconds of loading (Tc, m(60 s)), which is the resulting temperature when the S-value is exactly equal to the specification value of 300 MPa, from the BBR m-critical temperature at 60 seconds of loading (Tc, S(60 s)), which is the resulting temperature when the m-value is exactly equal to the specification value of 0.300. The creep stiffness of the asphalt binder represents the ability of the asphalt binder to resist deformation under constant load. The Federal Highway Association (FHWA)-ICT-21-015 Rheology-Chemical Based Procedure to Evaluate Additives/Modifiers Used in Asphalt Binders for Performance Enhancements: Phase 2” suggests a minimum of −5° C. for the ΔT_{c} for an asphalt binder aged in the PAV for 40 hours.

### BRIEF SUMMARY

In some embodiments, a cracking resistant asphalt binder comprises a high viscosity vacuum tower bottoms material having a vacuum viscosity greater than about 50,000 P at about 60° C., a low viscosity vacuum tower bottoms material, and a biomaterial comprising greater than about 80.0 weight percent bio-resin.

In some embodiments, a cracking resistant asphalt binder comprises greater than about 60.0 weight percent of a high viscosity vacuum tower bottom material having a vacuum viscosity greater than about 50,000 P at about 60° C., from about 10.0 weight percent to about 20.0 weight percent of a low viscosity vacuum tower bottoms material having a viscosity less than about 300 P at about 60° C., and greater than about 5.0 weight percent of a biomaterial, wherein the cracking resistant asphalt binder exhibits a ΔT_{c} after 40 hours PAV aging higher than about −4.0° C.

In some embodiments, a method of forming a cracking resistant asphalt binder includes providing a high viscosity vacuum tower bottoms material having a vacuum viscosity greater than about 50,000 P at about 60° C., and mixing a low viscosity vacuum tower bottoms material and a biomaterial with the high viscosity vacuum tower bottoms material to form a cracking resistant asphalt binder having a ΔT_{c} after 40-hour PAV aging higher than about −4.0° C.

In some embodiments, a method of forming a cracking resistant asphalt binder comprises forming a high viscosity vacuum tower bottoms material having a vacuum viscosity greater than about 50,000 P at about 60° C., forming a low viscosity vacuum tower bottoms material having a vacuum viscosity less than about 300 P at about 60° C., and mixing the low viscosity vacuum tower bottoms material and a biomaterial with the high viscosity vacuum tower bottoms material to form a cracking resistant asphalt binder, wherein the low viscosity vacuum tower bottoms material constitutes from about 10.0 weight percent to about 20.0 weight percent of the cracking resistant asphalt binder, and the biomaterial constitutes from about 5.0 weight percent to about 10.0 weight percent of the cracking resistant asphalt binder.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a simplified schematic of a system for forming (producing, generating) one or more materials that may be used as a component of a blended cracking resistant asphalt binder, according to at least one embodiment of the disclosure;

FIG. 2 is a simplified flow diagram illustrating a system for forming a cracking resistant asphalt binder from a high viscosity vacuum tower bottoms material and a blend of a low viscosity vacuum tower bottoms material and a biomaterial, according to at least one embodiment of the disclosure;

FIG. 3 is a simplified flow diagram illustrating a method of forming a cracking resistant asphalt binder, according to at least one embodiment of the disclosure;

FIG. 4 is a graph illustrating the distillation curve of a high viscosity vacuum tower bottoms material;

FIG. 5 is a graph illustrating the distillation curve of a low viscosity vacuum tower bottoms material;

FIG. 6 is a graph illustrating the high temperature compliance and the low temperature compliance of the different asphalt binders;

FIG. 7 is a graph illustrating the ΔT_{c} after 40-hour PAV aging of the different asphalt binders;

FIG. 8 is a is a graph illustrating the colloidal instability index of the different asphalt binders; and

FIG. 9 is a graph illustrating the composition of the different asphalt binders according to a SARA analysis.

### DETAILED DESCRIPTION

Various equipment and tests may be used to characterize the properties of the asphalt binders described herein. For example, a dynamic shear rheometer (DSR) may be used to characterize asphalt binder properties at high and intermediate temperatures. The DSR is also known as an “oscillator shear rheometer” and is used to measure the rheological properties of liquid asphalt binders at intermediate temperatures (e.g., about 20° C.) to high temperatures (e.g., about 64° C.). The DSR applies a shear stress (τ) and/or a shear strain (γ) to an asphalt binder. The complex shear modulus (G*) is a ratio of the applied shear stress to the resulting shear strain and corresponds to a measure of the total deformation (measured in, for example, kPa). The phase angle (δ) is related to the time lag between the input and output signals and provides a relative indication of the viscous and elastic behavior of the asphalt binder (and represents the ratio of elastic to viscous behavior, measured in degrees). Materials with a phase angle of 90° are completely viscous while materials with a phase angle of 0° are completely elastic. At intermediate temperatures, asphalt binders are generally viscoelastic (with a phase angle of about 45°).

A bending beam rheometer (BBR) and a direct tension (DT) device may be used to characterize the asphalt binder properties at low temperatures. For example, a BBR may be used to measure the rheological properties of liquid asphalt binders at low temperatures (e.g., about −12° C. or at different temperatures depending on the specification). A fixed static load is applied to an asphalt binder beam of known dimensions, and the resulting deflection is measured. The flexural stiffness is reported as a function of time to provide an indication of the low temperature stiffness and cracking potential of the asphalt binder.

Methods of aging an asphalt binder prior to various tests include rolling thin film oven (RTFO) aging and pressure aging vessel (PAV) aging. Rolling thin film oven simulates the aging (e.g., short-term aging) that occurs in a hot mix asphalt (HMA) facility as thin films of binder are exposed to heat and air. A sample is poured into a cylindrical bottle and rotated horizontally at about 163° C. (about 325° F.). Because RFTO-aged asphalt exhibits a stiffness higher than the stiffness of the unaged asphalt binder, the stiffness of the RFTO-aged asphalt binder is measured to determine whether the desirable viscoelastic properties of the asphalt binder have been maintained after aging. PAV aging methods are designed to simulate oxidation of the asphalt binder over the service life of pavement including the asphalt binder. In PAV methods, the asphalt binders are exposed to high temperature (e.g., about 100° C.) and air pressure (e.g., about 2.10 MPa) for 20 hours (or 40 hours) to simulate long-term aging.

The creep stiffness (S-value, or more simply, S) is a measure of the thermal stresses in the asphalt binder resulting from thermal contraction. If the thermal stresses are too high, cracking will occur. Higher S-values correspond to higher thermal stresses (and a higher likelihood of thermal cracking). The creep stiffness is calculated according to Equation (1) below:

$$S ( t ) = \frac{{PL}^{3}}{4 {bh}^{3} δ ( t )} ; \qquad ( 1 )$$

wherein P is the applied load in Newtons, L is the span length between the two supports (e.g., 102 mm), b is the beam width (e.g., 12.5 mm), h is the beam thickness (e.g., 6.25 mm), and δ(t) is the deflection (in mm) as a function of time.

The m-value of an asphalt binder represents the rate of change of the stiffness (e.g., the creep stiffness) of the asphalt binder with time and may be representative of the ability of the asphalt binder to relax stresses that develop due to thermal contraction. Determination of the m-value may include aging the asphalt binder in a PAV for a duration, such as for 20 hours or 40 hours. After aging, a beam is prepared from the 20-hour or 40-hour PAV aged asphalt binder. The beam may have, for example, a thickness of about 6.25 mm, a width of about 12.5 mm, and a length of about 125 mm. The beam sample may be tested using a BBR. For example, the beam may be submerged in a temperature-controlled fluid bath having a temperature, such as, for example, −10° C. or about −40° C., depending on the specification. A constant load (e.g., about 100 g (about 980 mN)) is applied to the midpoint of the beam for a specified time (e.g., about 60 seconds, about 240 seconds). The beam may be supported on, for example, stainless steel cylindrical bearings spaced about 102 mm apart, as specified in ASTM D6648 and AASHTO T313 standards. The deflection of the beam responsive to the load is measured as a function of time using a high-precision displacement transducer. The m-value is calculated as the slope of the logarithm of the stiffness curve (the S-value) versus the logarithm of time at the specified time (e.g., about 60 seconds, about 240 seconds). The m-value is shown in Equation (2) below:

$$m ( t ) = \frac{d log S ( t )}{d log ( t )} ; \qquad ( 2 )$$

wherein S is the creep stiffness of the asphalt binder at a given temperature, t is the loading time (typically measured at 60 seconds), and d represents the derivative operator (the rate of change) of the respective parameter (e.g., the creep stiffness, time). According to Equation (2), the m-value corresponds to how quickly the creep stiffness changes over time. In other words, the m-value is the rate at which the material relaxes stress under a constant load, wherein higher m-values correspond to better stress relaxation and lower susceptibility to thermal cracking.

The ΔT_{c} may correspond to the degree of embrittlement of the asphalt binder and may be calculated according to Equation (3) below:

$$Δ {T}_{C} = {T}_{{C}_{s} -} {T}_{{C}_{m}} ; \qquad ( 3 )$$

wherein T_{Cm} is the temperature at which the m-value equals 0.300 (referred to as the critical temperature for the m-value) and T_{Cs} is the temperature at which the creep stiffness equals 300 MPa (referred to as the critical temperature for the creep stiffness). A negative ΔT_{c} value below −5° C. may indicate or suggest embrittlement and reduced durability of the asphalt binder compared to asphalt binders having a relatively higher (less negative) ΔT_{c} value.

As used herein, a high temperature compliance (HTC) of an asphalt binder is the temperature at which the unaged DSR tested sample and the RFTO tested sample fails specifications of G*/sin(δ) equal to −1.0 kPa for the original unaged binder and/or G*/sin(δ) equal to 2.2 kPa after RTFO. The high temperature compliance represents the highest temperature at which the asphalt binder can resist rutting or deformation under load. The unaged and RFTO-aged asphalt binder are individually placed between parallel plates spaced by about 1 mm in a DSR, and one of the plates (e.g., the upper plate) oscillates to apply a sinusoidal shear stress or shear strain on the asphalt binder. The temperature is selected depending on the performance grade of the asphalt binder and is usually varied in 6° C. increments (e.g., 46° C., 52° C., 58° C., 64° C., 70° C., 76° C.). The DSR measures the resistance of the binder to shear deformation and determines the complex shear modulus (G*) and the phase angle (δ). One parameter for high temperature compliance is the value of G* divided by the sin(δ). Unaged asphalt binders having a G*/sin(δ) value greater than or equal to 1.0 meet Superpave PG specifications; and RFTO-aged binders having a G*/sin(δ) value greater than or equal to 2.2 meet Superpave PG specifications. The high temperature compliance for the unaged and RTFO aged asphalt binder can be interpolated according to Equation (4.1) and Equation (4.2), respectively, below:

$${T}_{HTC ( unaged )} = {T}_{low} + \frac{( log ( 1 ) + log ( {G}_{low}^{*} ) )}{( low ( {G}_{high}^{*} ) - log ( {G}_{low}^{*} )} \times ( {T}_{high} - {T}_{low} ) ; \qquad ( 4.1 )$$

$${T}_{HTC ( RTFO )} = {T}_{low} + \frac{( log ( 2.2 ) + log ( {G}_{low}^{*} ) )}{( low ( {G}_{high}^{*} ) - log ( {G}_{low}^{*} )} \times ( {T}_{high} - {T}_{low} ) ; \qquad ( 4.2 )$$

wherein T_{HTC} is the high temperature compliance in ° C. for the unaged and RTFO aged asphalt binders; T_{low} is the last temperature where the value of G*/sin(δ) was greater than or equal to 1.0 kPa for the unaged asphalt binder or 2.2 kPa for the RTFO aged asphalt binder; T_{high} is the first temperature where the value of G*/sin(δ) was less than 1.0 kPa for the unaged asphalt binder or 2.2 kPa for the RTFO aged asphalt binder; G*_{low} is the value of G*/sin(δ) at T_{low}; and G*_{high} is the value of G*/sin(δ) at T_{high}. The lower temperature between the temperature at which the value of G*/sin(δ) of the unaged asphalt binder equals 1.0 kPa and the temperature at which the value of G*/sin(δ) of the RTFO aged asphalt binder equals 2.2 kPa.

As used herein, a low temperature compliance (LTC) of an asphalt binder is the temperature at which the creep stiffness or the m-value of the asphalt binder fails specifications. The low temperature compliance represents the lowest temperature at which the binder can resist thermal cracking caused by cold weather stresses. The creep stiffness and the m-value of a PAV-aged asphalt binder may be measured. To have a low temperature compliance at a particular temperature, the creep stiffness of the asphalt binder after 60 seconds (S(60 s)) at the temperature must be less than or equal to 300 MPa and the m-value after 60 seconds (m(60 s)) at the temperature must be greater than or equal to 0.300. If the S(60 s) value exceeds 300 MPa or the m(60 s) value falls below 0.300, the asphalt binder fails and is not compliant at the temperature. The low temperature compliance temperature may be interpolated according to Equation (5) or Equation (6) below:

$${T}_{LTC ( S )} = {T}_{low} + \frac{( 300 - {S}_{low} )}{( {S}_{high} - {S}_{low} )} \times ( {T}_{high} - {T}_{low} ) ; \qquad ( 5 )$$

$${T}_{LTC ( m - value )} = {T}_{low} + \frac{( 0.3 - {m}_{low} )}{( {m}_{high} - {m}_{low} )} \times ( {T}_{high} - {T}_{low} ) ; \qquad ( 6 )$$

wherein T_{low} is the last temperature where S(60 s) was less than or equal to 300 MPa; T_{high} is the first temperature where S(60 s) was greater than 300 MPa; S_{low} is the creep stiffness at T_{low}; and S_{high} is the creep stiffness at T_{high}; m_{low} is the m-value at T_{low}; and m_{high} is the m-value at T_{high}. The LTC may be the higher temperature of the T_{LTC(S)} and the T_{LTC(m-value)}.

As used herein, a usable temperature range (UTR) of an asphalt binder is the difference between the high temperature compliance and the low temperature compliance of the asphalt binder. The usable temperature range is an indication of the span over which the asphalt binder performs as specified. A larger usable temperature range is an indication of better performance of the asphalt binder across various temperatures.

As used herein, a performance graded asphalt binder is an asphalt binder exhibiting a specified high temperature compliance and a low temperature compliance. As one example, a performance graded asphalt binder having a performance grade of PG 64-22 is an asphalt binder having a high temperature compliance of 64° C. and a low temperature compliance of −22° C. The performance grade of the asphalt binder may also provide an indication of the usable temperature range of the asphalt binder. For example, a PG 64-22 asphalt binder may have a usable temperature range of 86° C. (e.g., 64° C.−(−22° C.)=86° C.).

In some embodiments, a composition of a material (e.g., an asphalt material, a vacuum gas oil, a vacuum tower bottoms material, a biomaterial) may be determined according to the IP 469 “Determination of saturate, aromatic and polar components in petroleum products by thin layer chromatography and flame ionization detection.” A SARA (saturates, aromatics, resins, and asphaltenes) analysis may be performed with, for example, the Iatroscan MK-6 thin layer chromatograph, manufactured by Mitsubishi Chemical Medience Corporation, of Japan. The IATROSCAN is an automatic detector that performs quantitative analysis on organic mixtures separated on thin layer chromatography (TLC) and detected by Hydrogen Frame Ionization System (FID). The separation of components is performed on an exclusive thin layer chromatography media (CHROMAROD) in the same manner of normal phase TLC. The IP 469 Standard outlines a methodology for conducting a SARA analysis of the material and may be used to quantify the composition of the different components (saturates, aromatics, resins, and asphaltenes) (also referred to as “fractions”) in the material.

The different components are separated based on solubility using toluene, heptane, dichloromethane, and methanol. The saturates include non-polar hydrocarbons including alkanes and cycloalkanes; the aromatics include compounds with one or more aromatic rings; the resins include polar, non-asphaltene hydrocarbons; and the aromatics include highly polar, high molecular weight hydrocarbons that are insoluble in n-heptane (or n-pentane). Saturates elute using heptane, aromatics elute using a mixture of 80:20 toluene:heptane by volume, resins elute using a mixture of 95:5 dichloromethane:methanol by volume, while asphaltenes do not elute. Other methods of performing a SARA analysis include using n-heptane (or n-pentane) to precipitate asphaltenes from the sample, while the remaining soluble material (referred to as “maltenes”) is further fractionated using a chromatography column. In the chromatography column, a silica or alumina column is employed to separate the maltenes into saturates, aromatics, and resins using specific solvents of varying polarity. The column is loaded with the maltene solution (the heptane-soluble portion). The saturates are separated from the maltenes by elution using a non-polar solvent, such as n-hexane or heptane; followed by separation of the aromatics by elution using an aromatic-rich solvent, such as toluene or benzene. Finally, the resins are separated by elution using a polar solvent, such as dichloromethane (DCM), acetone, or methanol. Of course, methods of performing a SARA analysis other than that described are possible. For example, the asphaltenes may not be precipitated from the material prior to fractionating the sample in the chromatography column.

According to embodiments described herein, performance graded cracking resistant asphalt binders may be formed from a mixture of at least one asphalt component, such as a high viscosity vacuum tower bottoms material, and a hybrid blend of a low viscosity vacuum tower bottoms material and a biomaterial. The hybrid blend of the low viscosity vacuum tower bottoms material and the biomaterial may facilitate replacing heavy vacuum gas oil that may otherwise be used in the cracking resistant asphalt binder to soften the asphalt binder and alter the performance rating thereof. The biomaterial may include a resin content greater than about 80.0 weight percent and may be referred to herein as a “bio-resin.” In some embodiments, the resin content of the biomaterial is greater than about 90.0 weight percent, such as greater than about 95.0 weight percent. In some embodiments, the biomaterial is substantially free of saturates and aromatics.

The cracking resistant asphalt binder may include at least about 15.0 volume percent of the hybrid blend comprising the low viscosity vacuum tower bottoms material and the biomaterial, such as at least about 20.0 volume percent of the hybrid blend. In some embodiments, the cracking resistant asphalt binder includes at least about 10.0 volume percent of the low viscosity vacuum tower bottoms material, such as at least about 15.0 volume percent of the low viscosity vacuum tower bottoms material. The cracking resistant asphalt binder may include at least about 3.0 volume percent of the biomaterial, such as at least about 5.0 volume percent of the biomaterial.

The hybrid blend comprising the low viscosity vacuum tower bottoms material and the biomaterial increases the ΔT_{c} (makes the ΔT_{c} less negative) of the cracking resistant asphalt binder compared to a cracking resistant asphalt binder that includes a similar weight percent of the heavy vacuum gas oil as of the hybrid blend. Thus, rather than using a heavy vacuum gas oil as a softening component for the cracking resistant asphalt binder, the hybrid blend of the low viscosity vacuum tower bottoms and the biomaterial may be used as a softening component. As described above, for the same weight percent in the cracking resistant asphalt binder, the hybrid blend may improve (increase) the ΔT_{c} after 40-hour PAV aging compared to heavy vacuum gas oil. Thus, the cracking resistant asphalt binder including the hybrid blend may exhibit improved low temperature properties compared to conventional asphalt binders that include heavy vacuum gas oil. In addition, the use of the hybrid blend as a softening component in the cracking resistant asphalt binder may facilitate increasing the resin and aromatic content of the cracking resistant asphalt binder compared to the use of the heavy vacuum gas oil.

In addition to increasing the ΔT_{c} of the cracking resistant asphalt binder, the hybrid blend of the low viscosity vacuum tower bottoms material and the biomaterial may lower the colloidal instability index of the cracking resistant asphalt binder, indicating that the cracking resistant asphalt binder including the hybrid blend of the low viscosity vacuum tower bottoms exhibits improved stability compared to other cracking resistant asphalt binders, such as those formed from the high viscosity vacuum tower bottoms material and a heavy vacuum gas oil (and not including the hybrid blend). In some embodiments, the colloidal instability index of the cracking resistant asphalt binder is less than about 0.40, such as less than about 0.38, or even less than about 0.36. In addition, the hybrid blend facilitates increasing the resin fraction in the cracking resistant asphalt binder. For example, each of the biomaterial and the low viscosity vacuum tower bottoms may exhibit a relatively high weight percent of resins, increasing the resin content of the cracking resistant asphalt binder. In some embodiments, the cracking resistant asphalt binder has a resin content greater than about 25.0 weight percent, such as greater than about 30.0 weight percent, or even greater than about 35.0 weight percent. In some embodiments, the cracking resistant asphalt binder includes less than about 40.0 weight percent aromatics.

Accordingly, the addition of the hybrid blend including the low viscosity vacuum tower bottoms material and the biomaterial to the cracking resistant asphalt binder may reduce and/or eliminate the use of heavy vacuum gas oil in the cracking resistant asphalt binder. The heavy vacuum gas oil may be used in other materials and/or may be further refined to create more valuable products, increasing the profitability of the refinery. For example, the heavy vacuum gas oil may be catalytically cracked and/or hydrocracked to form lighter components, such as gasoline and distillates (e.g., jet fuel, kerosene, diesel). The cracking resistant asphalt binder including the hybrid blend may pass performance grade requirements, such as a ΔT_{c}.

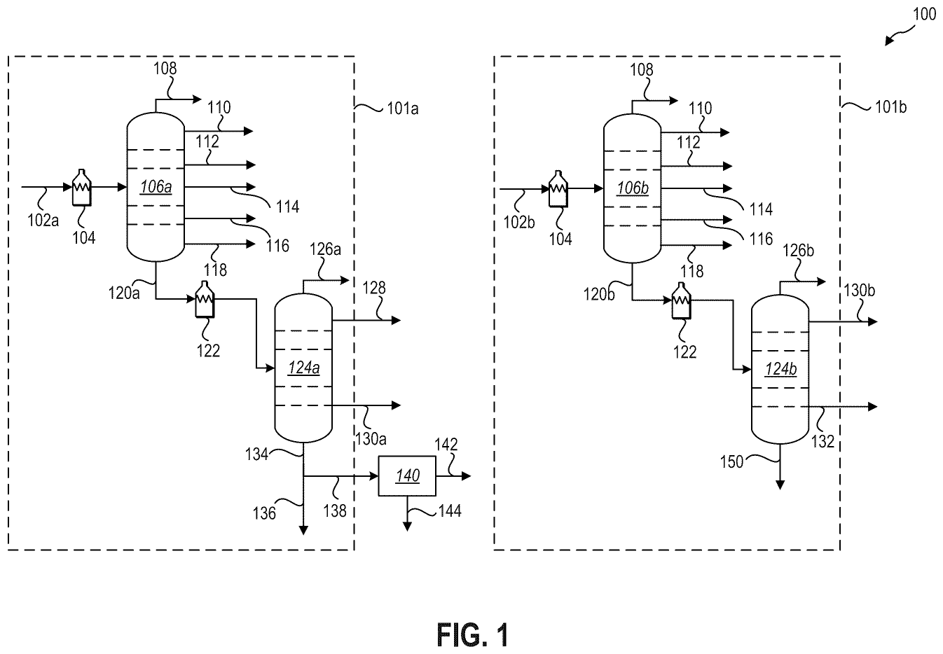

FIG. 1 is a simplified schematic of a system 100 for forming (producing, generating) one or more materials that may be used as a component of a blended cracking resistant asphalt binder, according to at least one embodiment of the disclosure. The system 100 may include one or more units configured to distill (refine) one or more crude oils and form one or more products therefrom. For example, the system 100 may include a first crude distillation unit 101a (also referred to as an “atmospheric crude distillation unit”) configured to distill (refine) a first crude oil 102a and form one or more products therefrom; and a second crude distillation unit 101b configured to distill a second crude oil 102b and form one or more products therefrom. The first crude distillation unit 101a and the second crude distillation unit 101b may be configured to refine the respective crude oil 102a, 102b into one or more components (e.g., fractions) based, at least in part, on the boiling point of the different components. The first crude distillation unit 101a and the second crude distillation unit 101b may collectively be referred to herein as the “crude distillation units 101” and the first crude oil 102a and the second crude oil 102b may collectively be referred to herein as “crude oil 102.” The first crude distillation unit 101a and the second crude distillation unit 101b may include a respective first atmospheric distillation tower 106a and a second atmospheric distillation tower 106b, which may collected by referred to herein as “atmospheric distillation towers 106.”

The properties of the crude oil 102 may depend on the type of crude oil 102 and may include any mixture of hydrocarbon materials. The crude oil 102 may be a low-density crude oil having an API gravity (wherein API gravity is equal to (141.5/SG)−131.5, wherein SG is the specific gravity) greater than about 40°, a medium-density crude oil having an API gravity between about 30° and about 40°, a high-density crude oil having an API gravity less than about 30°, or combinations thereof. In addition, the crude oil 102 may have a sulfur content, such as a sulfur content less than about 0.5 weight percent (e.g., a so-called “sweet” crude oil), a crude oil having a sulfur content greater than about 0.5 weight percent (e.g., a so-called “sour” crude oil), or combinations thereof. The crude oil 102 may include a paraffinic content, a naphthenic content, an aromatic content, or combinations thereof. The various fractions of the crude oil 102 may be separated from one another based on one or more of the density (gravity), the assay, or another property of the crude oil 102. Accordingly, the assay of the crude oil 102 may affect the fractions and the volume of different fractions of hydrocarbon products formed from the distillation of the crude oil 102. In some embodiments, the first crude distillation unit 101a and the second crude distillation unit 101b are configured to process different crude oils 102. For example, the first crude distillation unit 101a may be configured to process a first crude oil 102a and the second crude distillation unit 101b may be configured to process a second crude oil 102b having one or more different properties than the first crude oil 102a. In some embodiments, the first crude distillation unit 101a is configured to refine a first crude oil 102a having a lower density (higher API gravity) than the second crude oil 102b refined by the second crude distillation unit 101b.

Each of the crude distillation units 101 may include a furnace 104, which may also be referred to herein as a “crude furnace.” The furnace 104 may receive the crude oil 102 and provide thermal energy to the crude oil 102 to increase a temperature thereof prior to the crude oil 102 entering an atmospheric distillation tower 106 (also referred to herein as an “atmospheric distillation column” or a “crude tower”). The furnace 104 may include a cabin-type furnace, a cylindrical furnace, an A-frame furnace, or another type of furnace.

While FIG. 1 illustrates only certain components of the crude distillation units 101 and the system 100, it will be understood that the crude distillation units 101 and the system 100 may include components and devices in addition to those described. For example, the crude distillation units 101 may each include a desalter configured to remove salts and water from the crude oil 102 prior to introducing the crude oil 102 to the furnace 104 and the atmospheric distillation tower 106. In addition, the atmospheric distillation towers 106 may include additional streams (e.g., stripping steam, reflux streams, other streams) and may be in operable communication with one or more additional components (e.g., one or more pumps, heat exchangers). The system 100 may include pumps, valves, heat exchangers, or other process equipment for facilitating the recovery of hydrocarbon materials from the crude oil 102.

The first atmospheric distillation tower 106a may be configured to receive the heated first crude oil 102a from the furnace 104. A temperature of the first crude oil 102a entering the first atmospheric distillation tower 106a may be sufficient to facilitate separation of different components within the first crude oil 102a based on a boiling point range of the different components. The temperature of the first crude oil 102a entering the first atmospheric distillation tower 106a may be selected based, at least in part, on the composition of the first crude oil 102a (e.g., the crude assay), an operating pressure of the first atmospheric distillation tower 106a, and on the configuration (e.g., equipment, process units) of the system 100. By way of non-limiting example, the temperature of the first crude oil 102a may be within a range of from about 260° C. (about 550° F.) to about to 400° C. (about 752° F.), such as from about 260° C. (about 550° F.) to 315.6° C. (about 600° F.), from about 315.6° C. (about 600° F.) to about 343.3° C. (about 650° F.), from about 343.3° C. (about 650° F.) to about 371.1° C. (about 700° F.), or from about 371.1° C. (about 700° F.) to about 400° C. (about 752° F.). However, the disclosure is not so limited, and the temperature of the first crude oil 102a may be different than that described.

The first atmospheric distillation tower 106a may be configured to facilitate separation of the different components of the first crude oil 102a from one another to form one or more hydrocarbon fractions from the first crude oil 102a, each hydrocarbon fraction having a different boiling point range and/or one or more different properties than the other hydrocarbon fractions. The first atmospheric distillation tower 106a may include multiple trays including, for example, one or more of bubble cap trays, sieve trays, valve trays, or any other type of tray to facilitate vapor-liquid contact and separation based on boiling point. In some embodiments, the first atmospheric distillation tower 106a is configured to separate the first crude oil 102a into an overhead gaseous material 108 (also referred to as a “light ends” material), a light naphtha material 110, a heavy naphtha material 112, a jet material 114 (or a kerosene material), a diesel material 116, an atmospheric gas oil 118, and a first atmospheric tower bottoms material 120 (which may also be referred to as a first “atmospheric residue”).

The overhead gaseous material 108 may include, for example, non-condensable gases and/or liquified petroleum gases (LPG). The non-condensable gases may include one or more of hydrogen, methane, ethane, propane, or butane. The liquified petroleum gas may include one or more of propane, butanes, and other hydrocarbon materials. In some embodiments, the overhead gaseous material 108 is further processed in the system 100, such as in a gas recovery system.

The light naphtha material 110 may include, for example, pentane, hexane, other C₅ hydrocarbons, other C₆ hydrocarbons, or combinations thereof. The C₅ and C₆ hydrocarbons may be paraffins (e.g., n-pentane, n-hexane), isoparaffins (e.g., isopentane, isohexane), naphthenes (cyclopentane, cyclohexane), aromatics (e.g., benzene), or combinations thereof. The light naphtha material 110 may have a boiling point range from about 35° C. (about 95° F.) to about 90° C. (about 194° F.); a molecular weight range within a range of from about 70 g/mol to about 85 g/mol; a density at about 15° C. within a range of from about 0.65 g/cm³ to about 0.70 g/cm³; a Reid vapor pressure from about 6 psi to about 12 psi; a flash point less than about 0° C.; and a viscosity within a range of from about 0.4 cSt to about 0.5 cSt. The light naphtha material 110 may be further processed in the system 100, such as in a reformer and/or may be used as a blending component of gasoline. In some embodiments, the light naphtha material 110 is used as a feedstock to an isomerization unit. As used herein, a “boiling point range” refers to the temperature interval over which a material (a mixture of different materials) transitions from liquid to vapor and may be measured using a distillation test, such as ASTM D86 or ASTM D160.

The heavy naphtha material 112 may include, for example, C₇ to C₁₀ hydrocarbon materials and may include naphthenes, paraffins, higher aromatics (benzene, toluene, xylenes), or combinations thereof. The heavy naphtha material 112 may have a higher flash point, a higher boiling point range, a higher molecular weight, a higher density, and a higher viscosity than the light naphtha material 110. By way of non-limiting example, the heavy naphtha material 112 may have a boiling point range from about 90° C. (about 194° F.) to about 200° C. (about 392° F.); a molecular weight within a range of from about 85 g/mol to about 120 g/mol; a density at about 15° C. within a range of from about 0.70 g/cm³ to about 0.78 g/cm³; a Reid vapor pressure from about 3 psi to about 6 psi; a flash point within a range of from about 26.7° C. (about 80° F.) to about 37.8° C. (about 100° F.); and a viscosity within a range of from about 0.6 cSt to about 1.0 cSt. The heavy naphtha material 112 may be further processed in the system 100, such as in a catalytic reformer and/or may be used as a blending component of gasoline.

The jet material 114 may include, for example, a mixture of paraffins (e.g., from about 50 volume percent to about 70 volume percent), naphthenes (e.g., from about 20 volume percent to about 30 volume percent), and aromatics (e.g., from about 10 volume percent to about 20 volume percent). The jet material 114 may include, for example, C₉ to C₁₇ hydrocarbons. A boiling point range of the jet material 114 may be from about 175° C. to about 300° C., with a 10 percent recovery (recovered, boiled, evaporated) temperature within a range of from about 180° C. to about 211° C.; a 20 percent recovery temperature within a range of from about 199° C. to about 213° C.; a 50 percent recovery temperature within a range of from about 212° C. to about 229° C.; a 90 percent recovery temperature within a range of from about 236° C. to about 275° C.; and an endpoint temperature of about 300° C., and a minimum flash point of about 38° C. The jet material 114 may have a density within a range of from about 0.775 g/cm³ to about 0.840 g/cm³; a freezing point of about −40° C. or about −47° C.; and a viscosity less than about 8.0 cSt at about −20° C. The jet material 114 may be further processed in the system 100 to remove contaminants (e.g., mercaptans) therefrom. The jet material 114 may be blended to form a jet fuel (e.g., a jet A jet fuel, a jet A-1 jet fuel, a jet B jet fuel, or another jet fuel).

The diesel material 116 may include, for example, a mixture of paraffins (e.g., from about 30 volume percent to about 50 volume percent), naphthenes (e.g., from about 20 volume percent to about 40 volume percent), aromatics (e.g., from about 10 volume percent to about 30 volume percent), and olefins (e.g., less than about 5 volume percent). The diesel material 116 may include, for example, C₉ to C₂₀ hydrocarbon materials. A boiling point range of the diesel material 116 may be from about 220° C. to about 380° C., with an initial boiling point within a range of from about 160° C. to about 180° C.; a 10 percent recovery temperature within a range of from about 175° C. to about 210° C.; a 50 percent recovery temperature within a range of from about 210° C. to about 270° C.; a 90 percent recovery temperature within a range of from about 250° C. to about 325° C.; and an endpoint within a range of from about 275° C. to about 380° C. The diesel material 116 may exhibit a density within a range of from about 0.82 g/cm³ to about 0.85 g/cm³; a cetane number between about 40 and about 55; a minimum flash point of about 52° C.; and a viscosity between about 1.9 cSt and about 4.1 cSt at about 40° C. The diesel material 116 may be further processed in the system 100, such as in one or more hydrotreaters to remove (e.g., reduce) sulfur from the diesel material 116. The diesel material 116 may be blended to form a diesel fuel, stored in tankage, and/or provided to a terminal after removal of the sulfur therefrom.

The atmospheric gas oil (AGO) 118 may include C₁₂ to C₂₀ hydrocarbons. The atmospheric gas oil 118 may have a boiling point range of from about 250° C. (e.g., about 270° C.) to about 425° C. (e.g., about 370° C.). The atmospheric gas oil 118 may include a light gas oil, a heavy gas oil, or combinations thereof. The atmospheric gas oil 118 may exhibit a viscosity within a range of from about 2 cSt to about 10 cSt at about 40° C.; a density within a range of from about 0.83 g/cm³ to about 0.88 g/cm³; and a cetane number within a range of from about 35 to about 50. The system 100 may be configured to further process the atmospheric gas oil 118, such as in a hydrotreater, a hydrocracker (e.g., a fluid catalytic cracker), or another process.

The first atmospheric tower bottoms material 120a may include heavy atmospheric gas oil, asphaltenes, resins, polyaromatic hydrocarbons, and combinations thereof. The first atmospheric tower bottoms material 120a may have a boiling point range from about 343° C. (about 650° F.) to about 565.6° C. (about 1,050° F.). In some embodiments, the first atmospheric tower bottoms material 120a exhibits an initial boiling temperature from about 343.3° C. (about 650° F.) to about 371.1° C. (about 700° F.). A final boiling point (endpoint) of the first atmospheric tower bottoms material 120a may be greater than about 565.6° C. (about 1,050° F.). The first atmospheric tower bottoms material 120a may have a density within a range of from about 0.95 g/cm³ to about 1.05 g/cm³; a pour point greater than about 30° C.; a flash point greater than about 200° C.; and a viscosity greater than about 1,000 cSt at about 100° C.

With continued reference to FIG. 1, the first atmospheric tower bottoms material 120a may be further processed to separate lighter fractions (e.g., fractions having a lower boiling point range than heavier fractions) from the heavier fractions (e.g., fractions having a higher boiling point range than the lighter fractions). In some embodiments, the first atmospheric tower bottoms material 120a is processed in a distillation column or tower having a pressure lower than atmospheric pressure. In some embodiments, the first atmospheric tower bottoms material 120a may be provided to a low vacuum distillation tower 124a (also referred to as a “vacuum tower” or a “vacuum separation tower”).

The low vacuum distillation tower 124a may be configured to receive the first atmospheric tower bottoms material 120a and separate the first atmospheric tower bottoms material 120a into one or more materials having different boiling point ranges, such as a first overhead vapor material 126a, a light vacuum gas oil (LVGO) 128 (also referred to as a “low vacuum gas oil”) a first medium vacuum gas oil (MVGO) 130a, and a low viscosity vacuum tower bottoms (LVTB) material 134 (also referred to as a “light vacuum tower bottoms material”). In some embodiments, the first atmospheric tower bottoms material 120 is heated in a furnace 122 prior to being provided to the low vacuum distillation tower 124a. The temperature of the first atmospheric tower bottoms material 120a provided to the low vacuum distillation tower 124a may be within a range of from about 343.4° C. (about 650° F.) to about 454.4° C. (about 850° F.), however the disclosure is not so limited and the temperature of the first atmospheric tower bottoms material 120a may be different than that described.

A pressure of the low vacuum distillation tower 124a may be within a range of from about 50 mmHg absolute to about 100 mmHg absolute, such as from about 50 mmHg absolute to about 60 mmHg absolute, from about 60 mmHg absolute to about 70 mmHg absolute, from about 70 mmHg absolute to about 80 mmHg absolute, from about 80 mmHg absolute to about 90 mmHg absolute, or from about 90 mmHg absolute to about 100 mmHg absolute. In some embodiments, one or more properties (e.g., a vacuum viscosity, a high temperature compliance, a low temperature compliance) of the low viscosity vacuum tower bottoms material 134 depends, at least in part, on the pressure of the low vacuum distillation tower 124a.

The first overhead vapor material 126a may include C₁ to C₄ hydrocarbon materials and may be further processed in the system 100 by, for example, the gas recovery system. The light vacuum gas oil 128 may have a boiling point ranging from about 343° C. to about 455° C.; and the first medium vacuum gas oil 130a may have a boiling point ranging from about 455° C. to about 510° C.

The light vacuum gas oil 128 may exhibit a density within a range of from about 0.85 g/cm³ to about 0.88 g/cm³; a viscosity within a range of from about 2 cSt to about 5 cSt at about 100° C., a pour point within a range of from about −23° C. to about −1° C.; an aromatic content within a range of from about 20 weight percent to about 40 weight percent; and a flash point greater than about 93° C. The light vacuum gas oil 128 may be further processed in the system 100, such as in a hydrocracker, may be used as a blending component, or combinations thereof.

The first medium vacuum gas oil 130a may exhibit a density within a range of from about 0.88 g/cm³ to about 0.91 g/cm³; a viscosity within a range of from about 5 cSt to about 10 cSt at about 100° C., a pour point within a range of from about −6° C. to about 10° C.; an aromatic content within a range of from about 30 weight percent to about 50 weight percent; and a flash point greater than about 121° C. The first medium vacuum gas oil 130a may be further processed in the system 100, such as in a hydrocracker or a catalytic cracker, may be used as a blending component, or combinations thereof.

The low viscosity vacuum tower bottoms material 134 may exhibit a density within a range of from about 0.98 g/cm³ to about 1.10 g/cm³; a viscosity within a range of from about 50 cSt to about 500 cSt at about 100° C.; a pour point within a range of from about 27° C. to about 65° C.; and a flash point greater than about 149° C. However, the properties of the low viscosity vacuum tower bottoms material 134 are not so limited, and may be different than those described. The properties of the low viscosity vacuum tower bottoms material 134 may depend, at least in part, on the operating pressure of the low vacuum distillation tower 124a.

The low viscosity vacuum tower bottoms material 134 may have a vacuum viscosity within a range of from about 1 Poise (P) to about 300 P at about 60° C., such as from about 1 P to about 200 P, or from about 10 P to about 300 P at about 60° C. The vacuum viscosity of the low viscosity vacuum tower bottoms material 134 may be within a range of from about 1 P to about 300 P at about 60° C., such as within a range of from about 1 P to about 10 P, from about 10 P to about 50 P, from about 50 P to about 100 P, from about 100 P to about 150 P, from about 150 P to about 200 P, from about 200 P to about 250 P, or from about 250 P to about 300 P at about 60° C.

In some embodiments, the low viscosity vacuum tower bottoms material 134 has a vacuum viscosity less than about 300 P at about 60° C., such as less than about 250 P, less than about 200 P, less than about 150 P, less than about 100 P, less than about 50 P, less than about 25 P, or even less than about 10 P at about 60° C. In some embodiments, the vacuum viscosity of the low viscosity vacuum tower bottoms material 134 is less than about 200 P at about 60° C. In some embodiments, the vacuum viscosity of the low viscosity vacuum tower bottoms material 134 is within a range of from about 1 P to about 200 P at about 60° C. In some embodiments, the vacuum viscosity of the low viscosity vacuum tower bottoms material 134 is within a range of from about 10 P to about 300 P at about 60° C. As used herein, a vacuum viscosity refers to a viscosity measured according to ASTM D2171 (ASTM D217-07e1, ASTM D2171/D2171M-10, ASTM D2171/D2171M-22) measured at 60° C., which method is used to determine viscosity of asphalt index by vacuum capillary viscometers.

The low viscosity vacuum tower bottoms material 134 may include a bimodal distribution of C₆ to C₂₅ hydrocarbons and C₂₅ to C₃₅ hydrocarbons, as measured by using staged thermal extraction gas chromatography-mass spectrometry (TE GC-MS). The C₆ to C₂₅ hydrocarbons may be aliphatic and may be in the diesel range, and the C₂₅ to C₃₅ hydrocarbons may be aliphatic and may be in the vacuum gas oil range. As measured by pyrolysis gas chromatography-mass spectrometry (PY GC-MS), the low viscosity vacuum tower bottoms material 134 may include C₄ to C₂₃ hydrocarbons, such as a mixture of C₄ to C₂₃ olefinic and paraffinic hydrocarbons. In some embodiments, the low viscosity vacuum tower bottoms material 134 further includes up to C₂₉ paraffins. The mixture of C₄ to C₂₃ olefinic and paraffinic hydrocarbons may include pairs of olefinic and paraffinic C₄ to C₂₃ hydrocarbons.

A distillation curve of the low viscosity vacuum tower bottoms material 134 may be determined according to, for example, ASTM D7169M. The low viscosity vacuum tower bottoms material 134 may have an initial boiling point within a range of from about 404° C. (about 760° F.) to about 426.7° C. (about 800° F.), such as from about 410° C. (about 770° F.) to about 423° C. (about 794° F.), or from about 413° C. (about 775° F.) to about 423° C. (about 794° F.). In some embodiments, the initial boiling point of the low viscosity vacuum tower bottoms material 134 is about 413° C. (about 775° F.).

A temperature at which about 10.0 weight percent of the low viscosity vacuum tower bottoms material 134 boils off (is evaporated) (a T10 temperature) may be within a range of from about 510° C. (about 950° F.) to about 565.6° C. (about 1,050° F.), such as from about 521° C. (about 970° F.) to about 554.4° C. (about 1,030° F.), from about 526.7° C. (about 980° F.) to about 548.9° C. (about 1,020° F.), or from about 532.2° C. (about 990° F.) to about 543.3° C. (about 1,010° F.). In some embodiments, the T10 temperature of the low viscosity vacuum tower bottoms material 134 is less than about 554.4° C. (about 1,030° F.), such as less than about 548.9° C. (about 1,020° F.), or less than about 543.3° C. (about 1,010° F.). In some embodiments, the T10 temperature of the low viscosity vacuum tower bottoms material 134 is about 535° C. (about 995° F.).

A temperature at which about 30.0 weight percent of the low viscosity vacuum tower bottoms material 134 boils off (is evaporated) (a T30 temperature) may be within a range of from about 565.6° C. (about 1,050° F.) to about 615.6° C. (about 1,140° F.), such as from about 576.7° C. (about 1,070° F.) to about 604.4° C. (about 1,120° F.), or from about 582.2° C. (about 1,080° F.) to about 598.9° C. (about 1,110° F.). In some embodiments, the T30 temperature of the low viscosity vacuum tower bottoms material 134 is higher than about 565.6° C. (about 1,050° F.), such as higher than about 576.7° C. (about 1,070° F.). In some embodiments, the T30 temperature of the low viscosity vacuum tower bottoms material 134 is lower than about 615.6° C. (about 1,140° F.), such as lower than about 604.4° C. (about 1,120° F.), or lower than about 593.3° C. (about 1,100° F.). In some embodiments, the T30 temperature of the low viscosity vacuum tower bottoms material 134 is about 587.8° C. (about 1,090° F.).

A temperature at which about 50.0 weight percent of the low viscosity vacuum tower bottoms material 134 boils off (is evaporated) (a T50 temperature) may be within a range of from about 621.1° C. (about 1,150° F.) to about 676.7° C. (about 1,250° F.), or from about 598.9° C. (about 1,110° F.) to about 654.4° C. (about 1,210° F.), such as from about 610° C. (about 1,130° F.) to about 643.3° C. (about 1,190° F.), or from about 621° C. (about 1,150° F.) to about 632.2° C. (about 1,170° F.). In some embodiments, the T50 temperature of the low viscosity vacuum tower bottoms material 134 is less than about 648.9° C. (about 1,200° F.), such as less than about 637.8° C. (about 1,180° F.), or less than about 632.2° C. (about 1,170° F.).

A temperature at which about 70.0 weight percent of the low viscosity vacuum tower bottoms material 134 boils off (is evaporated) (a T70 temperature) may be within a range of from about 643.3° C. (about 1,190° F.) to about 698.9° C. (about 1,290° F.), such as from about 654.4° C. (about 1,210° F.) to about 687.8° C. (about 1,270° F.), or from about 665.6° C. (about 1,230° F.) to about 676.7° C. (about 1,250° F.). In some embodiments, the T70 temperature of the low viscosity vacuum tower bottoms material 134 is less than about 682.2° C. (about 1,260° F.), such as less than about 676.7° C. (about 1,250° F.).

A temperature at which about 90.0 weight percent of the low viscosity vacuum tower bottoms material 134 boils off (is evaporated) (a T90 temperature) may be within a range of from about 676.7° C. (about 1,250° F.) to about 726.7° C. (about 1,340° F.), or from about 690.6° C. (about 1,275° F.) to about 735° C. (about 1,355° F.), such as from about 698.9° C. (about 1,290° F.) to about 726.7° C. (about 1,340° F.), or from about 707.2° C. (about 1,305° F.) to about 718.3° C. (about 1,325° F.). In some embodiments, the T90 temperature of the low viscosity vacuum tower bottoms material 134 is less than about 732.2° C. (about 1,350° F.), such as less than about 726.7° C. (about 1,340° F.), less than about 721.1° C. (about 1,330° F.), or less than about 715.6° C. (about 1,320° F.).

An endpoint temperature of the low viscosity vacuum tower bottoms material 134 (a temperature at which substantially all of the low viscosity vacuum tower bottoms material 134 evaporates) may be within a range of from about 704.4° C. (about 1,300° F.) to about 748.9° C. (about 1,380° F.), such as from about 732.2° C. (about 1,350° F.) to about 743.3° C. (about 1,370° F.). In some embodiments, the endpoint temperature of the low viscosity vacuum tower bottoms material 134 is within a range of from about 715.6° C. (about 1,320° F.) to about 771.1° C. (about 1,420° F.), such as from about 726.7° C. (about 1,340° F.) to about 760° C. (about 1,400° F.), or from about 737.8° C. (about 1,360° F.) to about 748.9° C. (about 1,380° F.). In some embodiments, the endpoint temperature of the low viscosity vacuum tower bottoms material 134 is less than about 760° C. (about 1,400° F.), such as less than about 754.4° C. (about 1,390° F.), or less than about 748.9° C. (about 1,380° F.).

A composition of the low viscosity vacuum tower bottoms material 134 may be measured according to the IP 469 standard for determining the composition of saturates, aromatic, and polar compounds (including resins and asphaltenes) (a SARA analysis). As measured by the IP 469 standard, in some embodiments, the low viscosity vacuum tower bottoms material 134 includes from about 22.0 weight percent to about 35.0 weight percent saturates, such as from about 24.0 weight percent to about 33.0 weight percent saturates, from about 25.0 weight percent to about 32.0 weight percent saturates, from about 27.0 weight percent to about 29.0 weight percent saturates, or from about 26.1 weight percent to about 31.0 weight percent saturates); from about 30.0 weight percent to about 45.0 weight percent aromatics (such as from about 38.0 weight percent to about 42.0 weight percent resins, or from about 38.9 weight percent to about 43.7 weight percent aromatics); from about 15.0 weight percent to about 25.0 weight percent resins (such as from about 18.0 weight percent to about 22.0 weight percent resins, or from about 15.5 weight percent to about 16.5 weight percent resins); and from about 10.0 weight percent to about 15.0 weight percent asphaltenes (such as from about 11.0 weight percent to about 14.0 weight percent asphaltenes, or from about 13.0 weight percent to about 14.5 weight percent asphaltenes). However, the disclosure is not so limited, and the composition of the low viscosity vacuum tower bottoms material 134 may be different than that described. In some embodiments, the low viscosity vacuum tower bottoms material 134 includes from about 26.1 weight percent to about 31.0 weight percent saturates; from about 38.9 weight percent to about 43.7 weight percent aromatics; from about 15.5 weight percent to about 16.5 weight percent resins; and from about 13.0 weight percent to about 14.5 weight percent asphaltenes.

With continued reference to FIG. 1, the second crude distillation unit 101b may be substantially the same as the first crude distillation unit 101a, but may be configured to process a second crude oil 102b having one or more different properties than the first crude oil 102a. The second atmospheric distillation tower 106b may be substantially the same as the first atmospheric distillation tower 106a, but may be configured to process the second crude oil 102b having one or more different properties than the first crude oil 102a. In some embodiments, the first atmospheric distillation tower 106a and the second atmospheric distillation tower 106b are configured to be operated at different conditions (e.g., temperature, pressure) than one another. In some embodiments, the second crude oil 102b is a heavier crude oil than the first crude oil 102a, and the temperature of the second atmospheric distillation tower 106b is higher than the temperature of the first atmospheric distillation tower 106a.

The second atmospheric distillation tower 106b may be configured to form a second atmospheric tower bottoms material 120b having one or more different properties than the first atmospheric tower bottoms material 120a. In some embodiments, due to the different compositions of the first crude oil 102a and the second crude oil 102b, the properties (e.g., the distillation points, the distillation curves, the flash points, the freeze points, the pour points, the vapor pressure, the density, the sulfur content, other properties) of the overhead gaseous material 108, the light naphtha material 110, the heavy naphtha material 112, the jet material 114, the diesel material 116, the atmospheric gas oil 118, and/or the atmospheric tower bottoms materials 120 of the first atmospheric distillation tower 106a and the second atmospheric distillation tower 106b may be different from one another.

In some embodiments, the first atmospheric tower bottoms material 120a exhibits a lower density, lower distillation points (e.g., a lower 10 percent point, a lower 50 percent point, a lower 90 percent point, a lower endpoint), a lower flash point, and a lower sulfur content than the second atmospheric tower bottoms material 120b. In addition, in some embodiments, the second atmospheric tower bottoms material 120b may include a greater asphaltene content and a greater resin content than the first atmospheric tower bottoms material 120a. The first atmospheric tower bottoms material 120a may exhibit a higher paraffinic content than the second atmospheric tower bottoms material 120b.

In some embodiments, the second atmospheric tower bottoms material 120b exhibits a higher vacuum viscosity than the first atmospheric tower bottoms material 120a. A viscosity of the first atmospheric tower bottoms material 120a may be within a range of from about 100 cSt to about 1,000 cSt at about 100° C., and the viscosity of the second atmospheric tower bottoms material 120b may be greater than about 1,000 cSt at about 100° C.

As described above with reference to the first atmospheric tower bottoms material 120a, the second atmospheric tower bottoms material 120b may be further processed to separate the lighter fractions from the heavier fractions. In some embodiments, the second atmospheric tower bottoms material 120b is processed in a high vacuum distillation tower 124b. The high vacuum distillation tower 124b may be operated at a lower pressure (a higher vacuum) than the low vacuum distillation tower 124a. In some embodiments, the high vacuum distillation tower 124b is operated at a pressure within a range of from about 5 mmHg absolute to about 50 mmHg absolute, such as from about 5 mmHg to about 10 mmHg, from about 10 mmHg absolute to about 25 mmHg absolute, or from about 25 mmHg absolute to about 50 mmHg absolute.

The high vacuum distillation tower 124b may be configured to receive the second atmospheric tower bottoms material 120b and separate the second atmospheric tower bottoms material 120b into a second overhead vapor material 126b, a second medium vacuum gas oil 130b, a heavy vacuum gas oil (HVGO) 132 (also referred to as a “high vacuum gas oil”), and a high viscosity vacuum tower bottoms (HVTB) material 150 (also referred to as a “high vacuum tower bottoms material”). The second overhead vapor material 126b and the second medium vacuum gas oil 130b may be substantially the same as the first overhead vapor material 126a and the first medium vacuum gas oil 130a described above. The second overhead vapor material 126b and the second medium vacuum gas oil 130b may be substantially the same as those described above with reference to FIG. 1.

The heavy vacuum gas oil 132 may have a boiling point ranging from about 510° C. to about 566° C.; and the high viscosity vacuum tower bottoms material 150 may have a boiling point range greater than about 566° C. In some embodiments, the boiling point range of the heavy vacuum gas oil 132 may be different than that described above and may be, for example, from about 455° C. to about 566° C. The heavy vacuum gas oil 132 may exhibit a density within a range of from about 0.91 g/cm³ to about 0.95 g/cm³; a viscosity within a range of from about 10 cSt to about 20 cSt at about 100° C., a pour point within a range of from about 10° C. to about 27° C.; an aromatic content within a range of from about 40 weight percent to about 60 weight percent; and a flash point greater than about 149° C. The heavy vacuum gas oil 132 may be further processed in the system 100, such as in a hydrocracker or a catalytic cracker, may be used as a blending component, or combinations thereof.

A composition of the heavy vacuum gas oil 132 may be measured according to the IP 469 standard for determining the composition of saturates, aromatic, and polar compounds (including resins and asphaltenes). In some embodiments, the composition of the heavy vacuum gas oil 132 is measured using a SARA analysis. In some embodiments, the heavy vacuum gas oil 132 includes from about 46.0 weight percent to about 55.0 weight percent saturates, from about 34.0 weight percent to about 46.0 weight percent aromatics, from about 7.0 weight percent to about 15.0 weight percent resins, and from about 0.0 weight percent to about 1.0 weight percent asphaltenes.

Saturates may constitute at least about 40.0 weight percent of the heavy vacuum gas oil 132. Saturates may constitute from about 40.0 weight percent to about 60.0 weight percent of the heavy vacuum gas oil 132, such as from about 40.0 weight percent to about 45.0 weight percent, from about 45.0 weight percent to about 50.0 weight percent, from about 50.0 weight percent to about 55.0 weight percent, or from about 55.0 weight percent to about 60.0 weight percent of the heavy vacuum gas oil 132. In some embodiments, saturates constitute from about 46.0 weight percent to about 55.0 weight percent of the heavy vacuum gas oil 132.

Aromatics may constitute at least about 30.0 weight percent of the heavy vacuum gas oil 132. Aromatics may constitute from about 30.0 weight percent to about 50.0 weight percent of the heavy vacuum gas oil 132, such as from about 30.0 weight percent to about 35.0 weight percent, from about 35.0 weight percent to about 40.0 weight percent, from about 40.0 weight percent to about 45.0 weight percent, or from about 45.0 weight percent to about 50.0 weight percent of the heavy vacuum gas oil 132. In some embodiments, aromatics constitute from about 34.0 weight percent to about 46.0 weight percent of the heavy vacuum gas oil 132.

Resins may constitute at least about 5.0 weight percent of the heavy vacuum gas oil 132. Resins may constitute from about 5.0 weight percent to about 20.0 weight percent of the heavy vacuum gas oil 132, such as from about 5.0 weight percent to about 10.0 weight percent, from about 10.0 weight percent to about 15.0 weight percent, or from about 15.0 weight percent to about 20.0 weight percent of the heavy vacuum gas oil 132. In some embodiments, resins constitute from about 7.0 weight percent to about 15.0 weight percent of the heavy vacuum gas oil 132.

Asphaltenes may constitute less than about 2.0 weight percent, such as less than about 1.0 weight percent, less than about 0.50 weight percent, or less than about 0.10 weight percent of the heavy vacuum gas oil 132. Asphaltenes may constitute from about 0.0 weight percent to about 2.0 weight percent of the heavy vacuum gas oil 132, such as from about 0.10 weight percent to about 0.50 weight percent, from about 0.50 weight percent to about 1.0 weight percent, or from about 1.0 weight percent to about 2.0 weight percent of the heavy vacuum gas oil 132. In some embodiments, the heavy vacuum gas oil 132 is free of (e.g., substantially free of) asphaltenes.

A colloidal index (CI) of the heavy vacuum gas oil 132 may be within a range of from about 0.8 to about 1.2, such as from about 0.8 to about 1.0, or from about 1.0 to about 1.2. The colloidal index may be a representation of a likelihood of the heavy vacuum gas oil 132 to form sediments due to instability of the asphaltene particles therein. The colloidal index is calculated as the ratio between the aromatics and the resins to the asphaltenes and the saturates (i.e., colloidal index=(weight percent aromatics+weight percent resins)/(weight percent asphaltenes+weight percent saturates)). The colloidal instability index (CII) is the reciprocal of the colloidal index (i.e., colloidal instability index=(weight percent saturates+weight percent asphaltenes)/(weight percent resins+weight percent aromatics)). Generally, a lower CII indicates a greater stability (e.g., reduced tendency to precipitate asphaltenes), with a CII value lower than about 0.7 indicated stable asphaltenes.

The composition of the heavy vacuum gas oil 132 may be measured using staged thermal extraction gas chromatography-mass spectrometry (TE GC-MS) and/or using pyrolysis gas chromatography-mass spectrometry (PY GC-MS). As measured by staged thermal extraction gas chromatography-mass spectrometry, the heavy vacuum gas oil 132 may include C₁₁ to C₃₃ hydrocarbons (e.g., C₁₁ to C₃₃ vacuum gas oil-range aliphatic materials). The heavy vacuum gas oil 132 may further include a range of aliphatic materials including C₁₈ materials, trace 3 or 4 ring aromatics and thiophenes, as determined by TE GC-MS. In some embodiments, the heavy vacuum gas oil 132 includes a greater weight percent of C₁₈ hydrocarbons than other hydrocarbons, such as hydrocarbons in the C₁₁ to C₃₃ range. As measured by pyrolysis gas chromatography-mass spectrometry, the heavy vacuum gas oil 132 may not include appreciable organic materials.

The high viscosity vacuum tower bottoms material 150 may have a vacuum viscosity within a range of from about 60,000 P to about 200,000 P, such as from about 60,000 P to about 100,000 P, from about 100,000 P to about 150,000 P, or from about 150,000 P to about 200,000 P. The vacuum viscosity is measured at a temperature of 60° C. In some embodiments, the high viscosity vacuum tower bottoms material 150 has a vacuum viscosity greater than about 60,000 P, such as greater than about 100,000 P, or greater than about 150,000 P at 60° C. In some embodiments, the high viscosity vacuum tower bottoms material 150 does not substantially flow (e.g., noticeably flow) at room temperature (e.g., at a temperature within a range of from about 20° C. to about 25° C.).

The high viscosity vacuum tower bottoms material 150 may exhibit a high temperature compliance (as measured by DSR) greater than about 85° C. For example, the high temperature compliance of the high viscosity vacuum tower bottoms material 150 may be within a range of from about 85° C. to about 95° C., such as from about 85° C. to about 87° C., from about 87° C. to about 90° C., from about 90° C. to about 92° C., or from about 92° C. to about 95° C. In some embodiments, the high temperature compliance of the high viscosity vacuum tower bottoms material 150 is within a range of from about 87° C. to about 95° C. The high temperature compliance of the high viscosity vacuum tower bottoms material 150 may be greater than about 87° C., such as greater than about 90° C., or greater than about 92° C.

A low temperature compliance of an unaged and/or a 20-hour PAV aged high viscosity vacuum tower bottoms material 150 may be less than or equal to 0° C., such as within a range of from about −9° C. to about 0° C., such as from about −9° C. to about −6° C., from about −6° C. to about −3° C., or from about −3° C. to about 0° C. The low temperature compliance of a 20-hour PAV aged high viscosity vacuum tower bottoms material 150 may be less than about 0° C., such as less than about −3° C., or less than about −6° C. A usable temperature range of the high viscosity vacuum tower bottoms material 150 may be greater than about 90° C., such as greater than about 92° C., greater than about 93° C., greater than about 94° C., greater than about 95° C., or even greater than about 96° C.

A ΔT_{c} of the high viscosity vacuum tower bottoms material 150 may be greater than about −5° C. In other words, a minimum ΔT_{c} of the high viscosity vacuum tower bottoms may be about −5° C. As used herein, a ΔT_{c} that is greater or higher than a negative temperature (e.g., −5° C.) is closer to 0° C. than the negative temperature. In some embodiments, the ΔT_{c} of a 20-hour PAV aged or a 40-hour PAV aged high viscosity vacuum tower bottoms material 150 is greater than about −5° C., such as greater than about −4° C., −2° C., or 0° C. In other words, the ΔT_{c} of the high viscosity vacuum tower bottoms material 150 may be higher than about −5° C. after aging for 20 hours and after aging for 40 hours in a PAV. In some embodiments, the ΔT_{c} of the high viscosity vacuum tower bottoms material 150 after 20 hours of PAV aging is higher than about −3.0° C., or even higher than about −2.5° C. The ΔT_{c} of the high viscosity vacuum tower bottoms material 150 after 40 hours of PAV aging is higher than about −4.5° C., such as higher than about −4.0° C., or higher than about −3.5° C. In some embodiments, the ΔT_{c} of the high viscosity vacuum tower bottoms material 150 after PAV aging for 20 hours or 40 hours is greater than about −5° C., such as greater than about −4° C., −2° C., or 0° C.

The distillation curve of the high viscosity vacuum tower bottoms material 150 may be determined according to, for example, ASTM D7169M. The high viscosity vacuum tower bottoms material 150 may have an initial boiling point within a range of from about 480° C. (about 896° F.) to about 510° C. (about 950° F.), such as from about 490° C. (about 914° F.) to about 500° C. (about 932° F.). In some embodiments, the initial boiling point of the high viscosity vacuum tower bottoms material 150 may be higher than about 480° C. (about 896° F.), or higher than about 490° C. (about 914° F.). In some embodiments, the initial boiling point of the high viscosity vacuum tower bottoms material 150 is about 482.2° C. (about 900° F.). A temperature at which about 10.0 weight percent of the high viscosity vacuum tower bottoms material 150 boils off (is evaporated) (a T10 temperature) may be within a range of from about 537.8° C. (about 1,000° F.) to about 593.3° C. (about 1,100° F.), such as from about 540° C. (about 1,004° F.) to about 590° C. (about 1,094° F.), from about 550° C. (about 1,022° F.) to about 580° C. (about 1,076° F.), or from about 555° C. (about 1,031° F.) to about 570° C. (about 1,058° F.). In some embodiments, the T10 temperature of the high viscosity vacuum tower bottoms material 150 is higher than about 540° C. (about 1,004° F.), such as higher than about 550° C. (about 1,022° F.). In some embodiments, the T10 temperature of the high viscosity vacuum tower bottoms material 150 is about 563° C. (about 1045° F.).

A temperature at which about 30.0 weight percent of the high viscosity vacuum tower bottoms material 150 boils off (is evaporated) (a T30 temperature) may be within a range of from about 593.3° C. (about 1,100° F.) to about 648.9° C. (about 1,200° F.), such as from about 600° C. (about 1,112° F.) to about 640° C. (about 1,184° F.), or from about 610° C. (about 1,130° F.) to about 630° C. (about 1,166° F.). In some embodiments, the T30 temperature of the high viscosity vacuum tower bottoms material 150 is higher than about 600° C. (about 1,112° F.), such as higher than about 610° C. (about 1,130° F.). In some embodiments, the T30 temperature of the high viscosity vacuum tower bottoms material 150 is about 621° C. (about 1150° F.).

A temperature at which about 50.0 weight percent of the high viscosity vacuum tower bottoms material 150 boils off (is evaporated) (a T50 temperature) may be within a range of from about 648.9° C. (about 1,200° F.) to about 687.8° C. (about 1,270° F.), such as from about 650° C. (about 1,202° F.) to about 685° C. (about 1,265° F.), or from about 655° C. (about 1,211° F.) to about 675° C. (about 1,247° F.). In some embodiments, the T50 temperature of the high viscosity vacuum tower bottoms material 150 is higher than about 650° C. (about 1,202° F.), such as higher than about 655° C. (about 1,211° F.). In some embodiments, the T50 temperature of the high viscosity vacuum tower bottoms material 150 is about 665° C. (about 1229° F.).

A temperature at which about 70.0 weight percent of the high viscosity vacuum tower bottoms material 150 boils off (is evaporated) (a T70 temperature) may be within a range of from about 687.8° C. (about 1,270° F.) to about 721.1° C. (about 1,330° F.), such as from about 690° C. (about 1,274° F.) to about 720° C. (about 1,328° F.), or from about 695° C. (about 1,283° F.) to about 715° C. (about 1,319° F.). In some embodiments, the T70 temperature of the high viscosity vacuum tower bottoms material 150 is higher than about 690° C. (about 1,274° F.), such as higher than about 695° C. (about 1,283° F.). In some embodiments, the T70 temperature of the high viscosity vacuum tower bottoms material 150 is about 704° C. (about 1299° F.).

A temperature at which about 90.0 weight percent of the high viscosity vacuum tower bottoms material 150 boils off (is evaporated) (a T90 temperature) may be within a range of from about 760.0° C. (about 1,400° F.) to about 787.8.7° C. (about 1,450° F.), such as from about 765.6° C. (about 1,410° F.) to about 782.2° C. (about 1,440° F.). In some embodiments, the T90 temperature of the high viscosity vacuum tower bottoms material 150 is higher than about 760.0° C. (about 1,400° F.), such as higher than about 771.1° C. (about 1,420° F.).

An endpoint temperature of the high viscosity vacuum tower bottoms material 150 (a temperature at which substantially all of the high viscosity vacuum tower bottoms material 150 evaporates) may be within a range of from about 787.8° C. (about 1,450° F.) to about 843.3° C. (about 1,550° F.), such as from about 804.4° C. (about 1,480° F.) to about 826.7° C. (about 1,520° F.). In some embodiments, the endpoint temperature of the high viscosity vacuum tower bottoms material 150 is higher than about 810° C. (about 1,490° F.), such as higher than about 815.6° C. (about 1,500° F.). In some embodiments, the endpoint temperature of the high viscosity vacuum tower bottoms material 150 is about 820° C. (about 1,508° F.).

A composition of the high viscosity vacuum tower bottoms material 150 may be measured according to the IP 469 standard for determining the composition of saturates, aromatic, and polar compounds (including resins and asphaltenes) (a SARA analysis). As measured by the IP 469 standard, in some embodiments, the high viscosity vacuum tower bottoms material 150 includes from about 3.0 weight percent to about 5.0 weight percent saturates, from about 30.0 weight percent to about 45.0 weight percent aromatics, from about 29.0 weight percent to about 45.0 weight percent resins, and from about 21.0 weight percent to about 25.0 weight percent asphaltenes. However, the disclosure is not so limited, and the composition of the high viscosity vacuum tower bottoms material 150 may be different than that described.

Saturates may constitute at least about 2.0 weight percent of the high viscosity vacuum tower bottoms material 150, such as at least about 3.0 weight percent of the high viscosity vacuum tower bottoms material 150. Saturates may constitute from about 2.0 weight percent to about 10.0 weight percent of the high viscosity vacuum tower bottoms material 150, such as from about 2.0 weight percent to about 3.0 weight percent, from about 3.0 weight percent to about 4.0 weight percent, from about 4.0 weight percent to about 5.0 weight percent, from about 5.0 weight percent to about 7.0 weight percent, or from about 7.0 weight percent to about 10.0 weight percent of the high viscosity vacuum tower bottoms material 150. In some embodiments, saturates constitute from about 3.0 weight percent to about 5.0 weight percent of the high viscosity vacuum tower bottoms material 150.

Aromatics may constitute at least about 20.0 weight percent of the high viscosity vacuum tower bottoms material 150, such as at least about 25.0 weight percent, or at least about 30.0 weight percent of the high viscosity vacuum tower bottoms material 150. Aromatics may constitute from about 20.0 weight percent to about 50.0 weight percent of the high viscosity vacuum tower bottoms material 150, such as from about 20.0 weight percent to about 30.0 weight percent, from about 30.0 weight percent to about 35.0 weight percent, from about 35.0 weight percent to about 40.0 weight percent, from about 40.0 weight percent to about 45.0 weight percent, or from about 45.0 weight percent to about 50.0 weight percent of the high viscosity vacuum tower bottoms material 150. In some embodiments, aromatics constitute from about 30.0 weight percent to about 45.0 weight percent of the high viscosity vacuum tower bottoms material 150.

Resins may constitute at least about 20.0 weight percent of the high viscosity vacuum tower bottoms material 150, such as at least about 25.0 weight percent of the high viscosity vacuum tower bottoms material 150. Resins may constitute from about 20.0 weight percent to about 50.0 weight percent of the high viscosity vacuum tower bottoms material 150, such as from about 20.0 weight percent to about 29.0 weight percent, from about 29.0 weight percent to about 35.0 weight percent, from about 35.0 weight percent to about 40.0 weight percent, from about 40.0 weight percent to about 45.0 weight percent, or from about 45.0 weight percent to about 50.0 weight percent of the high viscosity vacuum tower bottoms material 150. In some embodiments, resins constitute from about 29.0 weight percent to about 45.0 weight percent of the high viscosity vacuum tower bottoms material 150.

Asphaltenes may constitute at least about 15.0 weight percent of the high viscosity vacuum tower bottoms material 150, such as at least about 20.0 weight percent of the high viscosity vacuum tower bottoms material 150. Asphaltenes may constitute from about 15.0 weight percent to about 35.0 weight percent of the high viscosity vacuum tower bottoms material 150, such as from about 15.0 weight percent to about 18.0 weight percent, from about 18.0 weight percent to about 21.0 weight percent, from about 21.0 weight percent to about 23.0 weight percent, from about 23.0 weight percent to about 25.0 weight percent, from about 25.0 weight percent to about 27.0 weight percent, from about 27.0 weight percent to about 30.0 weight percent, or from about 30.0 weight percent to about 35.0 weight percent of the high viscosity vacuum tower bottoms material 150. In some embodiments, asphaltenes constitute from about 21.0 weight percent to about 25.0 weight percent of the high viscosity vacuum tower bottoms material 150.

The high viscosity vacuum tower bottoms material 150 may exhibit a colloidal instability index (CII) within a range of from about 0.30 to about 0.40, such as from about 0.30 to about 0.35, or from about 0.35 to about 0.40. The colloidal instability index may be a representation of a likelihood of high viscosity vacuum tower bottoms material 150 to form sediments due to instability of the asphaltene particles therein.

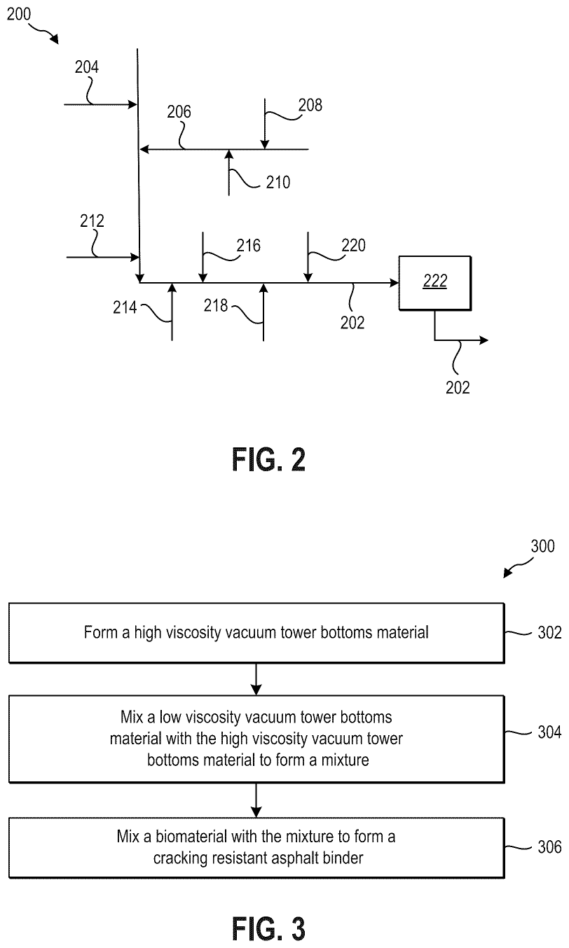

With continued reference to FIG. 1, each of the low viscosity vacuum tower bottoms material 134 and the high viscosity vacuum tower bottoms material 150 may be further processed and/or provided as a blend component, such as in an asphalt binder. For example, a first portion 136 of the low viscosity vacuum tower bottoms material 134 and the high viscosity vacuum tower bottoms material 150 may be further processed in the system 100, such as in one or more of a hydrocracker or a catalytic cracker; may be provided to tankage; and/or may be used as a component of an asphalt binder (e.g., as a component of a cracking resistant asphalt binder 202 (FIG. 2)).

A second portion 138 of the low viscosity vacuum tower bottoms material 134 may be further processed in an asphalt processing system 140 configured to remove (e.g., strip, extract) asphaltenes and heavier residual components from at least a portion of the low viscosity vacuum tower bottoms material 134 or other heavy oil streams to produce a deasphalted oil (DAO)) 142 and a hard asphalt 144 (also referred to as “pitch,” or “0-10 pen” (short for 0-10 dmm penetration)).

The asphalt processing system 140 may include, for example, a solvent deasphalting (SDA) unit. For example, the asphalt processing system 140 may include an asphaltene separator (also referred to as a “deasphalting column,” a “deasphalting tower,” an “asphaltene extractor,” or an “extractor”) configured to receive the second portion 138 of the low viscosity vacuum tower bottoms material 134 and a solvent to selectively separate (e.g., dissolve) lighter components from the heavier components to form the deasphalted oil 142 and the first hard asphalt 144. The asphalt processing system 140 may include additional components to facilitate the separation of the deasphalted oil 142 from the hard asphalt 144. By way of non-limiting example, the asphalt processing system 140 may include a deasphalted oil separator configured to separate the deasphalted oil 142 from the solvent, a stripper (e.g., a steam stripper) configured to separate the deasphalted oil 142 from additional solvent, and an asphaltene stripper configured to separate the solvent from the hard asphalt 144. The solvent may include, for example, propane, n-butane and/or isobutane. In some embodiments, the solvent includes a mixture of n-butane and isobutane and the hard asphalt 144 includes SDA pitch.

The conditions of the asphalt processing system 140, as well as the properties of the low viscosity vacuum tower bottoms material 134 (and the conditions of the low vacuum distillation tower 124a) may affect the properties of the hard asphalt 144. The hard asphalt 144 may exhibit a vacuum viscosity greater than about 200,000 P, such as greater than about 500,000 P, greater than about 750,000 P, greater than about 1,000,000 P, greater than about 1,500,000 P, greater than about 2,000,000 P, greater than about 3,000,000 P, greater than about 4,000,000 P, or even greater than about 5,000,000 P at about 60° C. In some embodiments, the vacuum viscosity of the hard asphalt 144 is greater than about 1,000,000 P at about 60° C. In some embodiments, the rotational viscosity of the hard asphalt 144 is greater than about 10,000 cP at about 135° C., such as greater than about 20,000 cP, greater than about 30,000 cP, greater than about 40,000 cP, or greater than about 50,000 cP at about 135° C.

A penetration of the hard asphalt 144 may be measured with a penetration test wherein the hard asphalt 144 is placed in a standardized container, cooled to about 25° C., and a needle is allowed to penetrate the sample under a load of about 100 grams for 5 seconds. The depth of the needle is measured and recorded in tenths of a millimeter (dmm). The hard asphalt 144 may exhibit a penetration within a range of from about 0.0 dmm to about 10 dmm at about 25° C., such as from about 0.0 dmm to about 1.0 dmm, from about 1.0 dmm to about 2.0 dmm, from about 2.0 dmm to about 4.0 dmm, from about 4.0 dmm to about 6.0 dmm, from about 6.0 dmm to about 8.0 dmm, or from about 8.0 dmm to about 10.0 dmm at about 25° C. In some embodiments, the penetration of the first hard asphalt 144 is less than about 3.0 dmm, such as less than about 2.0 dmm, less than about 1.0 dmm, less than about 0.5 dmm, less than about 0.2 dmm, or even less than about 0.1 dmm. In some embodiments, the penetration of the first asphalt 144 at about 25° C. is about 0 dmm (e.g., no penetration).

The hard asphalt 144 may exhibit a softening point within a range of from about 65.6° C. (about 150° F.) to about 104.4° C. (about 220° F.), such as from about 65.6° C. (about 150° F.) to about 76.7° C. (about 170° F.), from about 76.7° C. (about 170° F.) to about 87.9° C. (about 190° F.), from about 87.9° C. (about 190° F.) to about 93.3° C. (about 200° F.), from about 93.3° C. (about 200° F.) to about 98.9° C. (about 210° F.), or from about 98.9° C. (about 210° F.) to about 104.4° C. (about 220° F.). In some embodiments, the softening point of the hard asphalt 144 is greater than about 93.3° C. (about 200° F.), such as greater than about 98.9° C. (about 210° F.), or greater than about 104.4° C. (about 220° F.). The softening point of the hard asphalt 144 may be (correspond to) the temperature at which the hard asphalt 144 transitions from a solid phase to a more pliable or semi-liquid phase under specific conditions. The softening point may be determined using standardized tests, such as the Ring-and-Ball test (ASTM D36 or EN 1427) wherein a steel ball is placed on a sample of the hard asphalt 144 and the temperature is increased at a controlled rate. The softening point is the temperature where the hard asphalt 144 softens to allow the ball to drop a specified distance (about 25 mm). The steel ball may have a weight of about 3.5 grams.

The hard asphalt 144 may exhibit a high temperature compliance of at least about 85° C., such as at least about 86° C., at least about 87° C., at least about 88° C., at least about 89° C., or even at least about 90° C. In some embodiments, the high temperature compliance of the hard asphalt 144 is less than the high temperature compliance of the high viscosity vacuum tower bottoms material 150. In some embodiments, the high temperature compliance of the hard asphalt 144 is greater than the high temperature compliance of the high viscosity vacuum tower bottoms material 150. The hard asphalt 144 may exhibit a low temperature compliance greater than about −12° C., such as greater than about −10° C., greater than about −8° C., greater than about −6° C., or greater than about −5° C.

In some embodiments, as measured by TE GC-MS, the hard asphalt 144 may include a bimodal distribution of C₆ to C₂₈ hydrocarbons and C₂₈ to C₃₉ gas oil. The C₆ to C₂₈ hydrocarbons may be aliphatic hydrocarbons, such as distillate range aliphatic compounds. The C₂₈ to C₃₉ hydrocarbons may be aliphatic hydrocarbons, such as gas-oil range aliphatic hydrocarbons. As measured by PY GC-MS, the hard asphalt 144 may include C₆ to C₂₅ hydrocarbons, such as a mixture of C₆ to C₂₅ olefinic and paraffinic hydrocarbons. In some embodiments, the hard asphalt 144 further includes up to C₄₀ paraffins. The mixture of C₆ to C₂₅ olefinic and paraffinic hydrocarbons may include pairs of olefinic and paraffinic C₆ to C₂₅ hydrocarbons.

The hard asphalt 144 may include from about 0.8 weight percent to about 3.8 weight percent of saturates, from about 24.0 weight percent to about 41.6 weight percent of aromatics, from about 25.6 weight percent to about 37.7 weight percent of resins, and from about 16.8 weight percent to about 25.6 weight percent of asphaltenes, as measured by the IP 469 standard, the hexane method, and/or IATROSCAN-SARA testing (which is based on thin layer chromatography with flame ionization detection (TLC-FID)). A colloidal index of the hard asphalt 144 may be within a range of from about 0.268 to about 0.388, such as from about 0.268 to about 0.290, from about 0.290 to about 0.320, from about 0.320 to about 0.350, or from about 0.350 to about 0.388.

By way of non-limiting example, saturates may constitute from about 0.8 weight percent to about 3.8 weight percent of the hard asphalt 144, such as from about 0.8 weight percent to about 1.5 weight percent, from about 1.5 weight percent to about 2.0 weight percent, from about 2.0 weight percent to about 3.0 weight percent, or from about 3.0 weight percent to about 3.8 weight percent of the hard asphalt 144. Aromatics may constitute from about 24.0 weight percent to about 41.6 weight percent of the hard asphalt 144, such as from about 24.0 weight percent to about 30.0 weight percent, from about 30.0 weight percent to about 35.0 weight percent, from about 35.0 weight percent to about 40.0 weight percent, or from about 40.0 weight percent to about 41.6 weight percent of the hard asphalt 144. Resins may constitute from about 25.6 weight percent to about 37.7 weight percent of the hard asphalt 144, such as from about 25.6 weight percent to about 30.0 weight percent, from about 30.0 weight percent to about 35.0 weight percent, or from about 35.0 weight percent to about 37.7 weight percent of the hard asphalt 144. Asphaltenes may constitute from about 16.8 weight percent to about 25.6 weight percent of the hard asphalt 144, such as from about 16.8 weight percent to about 20.0 weight percent, from about 20.0 weight percent to about 23.0 weight percent, or from about 23.0 weight percent to about 25.6 weight percent of the hard asphalt 144. In some embodiments, the hard asphalt 144 includes asphaltenes and resins. In some embodiments, the hard asphalt 144 includes at least about 10.0 weight percent asphaltenes, such as at least about 15.0 weight percent, at least about 20.0 weight percent, or at least about 23.0 weight percent asphaltenes. The hard asphalt 144 may include at least about 20.0 weight percent resins, such as at least about 25.0 weight percent, at least about 30.0 weight percent, or even at least about 35.0 weight percent resins. In some embodiments, the hard asphalt 144 includes at least about 10.0 weight percent aromatics, such as at least about 15.0 weight percent, or at least about 20.0 weight percent aromatics.

In some embodiments, a weight ratio of the resins to the aromatics in the hard asphalt 144 is greater than about 6.0:1.0. In other words, for every about 1.0 part by weight of aromatics in the hard asphalt 144, the hard asphalt 144 may include at least about 6.0 parts by weight of resin. The hard asphalt 144 may include at least about 6.0 parts by weight of the resin for every about 1.0 part by weight of aromatics, such as at least about 10.0 parts by weight, at least about 20.0 parts by weight, at least about 30.0 parts by weight, at least about 40.0 parts by weight, or even at least about 50.0 parts by weight of resin for every about 1.0 part by weight of aromatics. In some embodiments, the relatively high ratio of the resins in the hard asphalt 144 may increase the ductility and adhesion of the asphalt binder formed from the hard asphalt 144. In some embodiments, the hard asphalt 144 includes at least about 0.5 part by weight of the aromatics for every about 1.0 part by weight of asphaltenes.

In some embodiments, the solvent of the asphalt processing system 140 is propane and the hard asphalt comprises PDA pitch. The PDA pitch may include from about 0.0 weight percent to about 1.0 weight percent saturates, from about 60.0 weight percent to about 70.0 weight percent aromatics, from about 20.0 weight percent to about 30.0 weight percent resins, and from about 10.0 weight percent to about 20.0 weight percent asphaltenes, as measured by IP 469 standard. As measured by the hexane method, the PDA pitch may include from about 0.0 weight percent to about 1.0 weight percent saturates, from about 50.0 weight percent to about 60.0 weight percent aromatics, from about 30.0 weight percent to about 35.0 weight percent resins, and from about 10.0 weight percent to about 15.0 weight percent asphaltenes. In some embodiments, the PDA pitch includes at least some resins and at least some asphaltenes. For example, the PDA pitch may include at least about 20.0 weight percent resins, such as at least about 25.0 weight percent, at least about 30.0 weight percent, or even at least about 35.0 weight percent resin. The PDA pitch may include at least about 5.0 weight percent asphaltenes, such as at least about 10.0 weight percent, or at least about 15.0 weight percent asphaltenes. The PDA pitch may include at least about 40.0 weight percent aromatics, such as at least about 45.0 weight percent, or at least about 50.0 weight percent aromatics. A colloidal index of the PDA pitch may be within a range of from about 0.09 to about 0.20, such as from about 0.09 to about 0.12, from about 0.12 to about 0.15, from about 0.15 to about 0.18, or from about 0.18 to about 0.20.

In some embodiments, the low viscosity vacuum tower bottoms material 134 may be mixed with a biomaterial to form a hybrid blend of the low viscosity vacuum tower bottoms material 134 and the biomaterial. The hybrid blend may be mixed with the high viscosity vacuum tower bottoms material 150 to form a cracking resistant asphalt binder. The cracking resistant asphalt binder may exhibit a performance grade of PG 64-22 or PG 58-28, a ΔT_{c} greater than −5° C. after aging for 40 hours in a PAV, a colloidal instability index less than about 0.40, and a resin content greater than about 30.0 weight percent. The hybrid blend in the cracking resistant asphalt binder may reduce or eliminate a requirement for other softening point additives, such as gas oils (e.g., the heavy vacuum gas oil 132, the medium vacuum gas oils 130a, 130b, the low vacuum gas oil 128) in the cracking resistant asphalt binder, allowing such other materials to be further processed to create more valuable products.

FIG. 2 is a simplified flow diagram illustrating a system 200 for forming a cracking resistant asphalt binder 202 from a high viscosity vacuum tower bottoms material 204 and a hybrid blend 206 comprising a low viscosity vacuum tower bottoms material 208 and a biomaterial 210, according to at least one embodiment of the disclosure. The cracking resistant asphalt binder 202 is formed by mixing the hybrid blend 206 with the high viscosity vacuum tower bottoms material 204. In some embodiments, the hybrid blend 206 is mixed with the high viscosity vacuum tower bottoms material 204 in-situ to form the cracking resistant asphalt binder 202. In some embodiments, the hybrid blend 206 is mixed with the high viscosity vacuum tower bottoms material 204 in one or more tanks 222 to form the cracking resistant asphalt binder 202. In some embodiments, at least one component (e.g., each component) of the cracking resistant asphalt binder 202 is provided from a tank 222 and blended to form the cracking resistant asphalt binder 202. In some embodiments, at least one component of the cracking resistant asphalt binder 202 is directly blended (such as from a process unit (e.g., the low vacuum distillation tower 124a, the high vacuum distillation tower 124b)) to form the cracking resistant asphalt binder 202 without providing the at least one component to the tank 222. In other words, one or more components of the cracking resistant asphalt binder 202 may be directly mixed after processing in the system 100. The addition of the hybrid blend 206 to the high viscosity vacuum tower bottoms material 204 may facilitate softening the high viscosity vacuum tower bottoms material 204 to form the cracking resistant asphalt binder 202 having a lower vacuum viscosity and a lower stiffness compared to the high viscosity vacuum tower bottoms material 204.

While FIG. 2 illustrates that the hybrid blend 206 is mixed with the high viscosity vacuum tower bottoms material 204 as a mixture of the low viscosity vacuum tower bottoms material 208 and the biomaterial 210, the disclosure is not so limited. In some embodiments, the low viscosity vacuum tower bottoms material 208 and the biomaterial 210 may be mixed with the high viscosity vacuum tower bottoms material 204 separately (e.g., not as a mixture comprising the hybrid blend 206). In some embodiments, the cracking resistant asphalt binder 202 comprises, consists essentially of, or consists of the high viscosity vacuum tower bottoms material 204 and the hybrid blend 206. In some embodiments, the cracking resistant asphalt binder 202 comprises, consists essentially of, or consists of the high viscosity vacuum tower bottoms material 204, the low viscosity vacuum tower bottoms material 208, and the biomaterial 210. In addition, while FIG. 2 illustrates that the hybrid blend 206 is mixed with the high viscosity vacuum tower bottoms material 204, the disclosure is not so limited. In some embodiments, the hybrid blend 206 is mixed with another asphalt binder material, such as straight asphalt. Straight asphalt may refer to and include petroleum asphalt obtained by refining and include a fraction that remains after distillation of crude oil (e.g., crude oil 102). The straight asphalt may be unmodified asphalt, such as the residual fraction obtained from vacuum distillation of atmospheric residue (e.g., obtained directly from distillation of crude oil and without the addition of performance-enhancing modifiers or additives).

In some embodiments, the cracking resistant asphalt binder 202 further includes one or more additional components. The one or more additional components may include one or more of a heavy vacuum gas oil 212, a medium vacuum gas oil 214, a hard asphalt 216, a deasphalted oil 218, or one or more additives 220. The one or more of the heavy vacuum gas oil 212, the medium vacuum gas oil 214, the hard asphalt 216, and the deasphalted oil 218 may be formed in the system 100. The heavy vacuum gas oil 212 may be the same as the heavy vacuum gas oil 132; the medium vacuum gas oil 214 may be the same as the first medium vacuum gas oil 130a and/or the second medium vacuum gas oil 130b; the hard asphalt 216 may be the same as the hard asphalt 144; and the deasphalted oil 218 may be the same as the deasphalted oil 142. In some embodiments, the cracking resistant asphalt binder 202 is free of and does not include gas oils (e.g., the heavy vacuum gas oil 212, the medium vacuum gas oil 214). In some embodiments, the cracking resistant asphalt binder 202 is free of and does not include any of the heavy vacuum gas oil 212, the medium vacuum gas oil 214, the hard asphalt 216, the deasphalted oil 218, or the one or more additives 220.

The additives 220 may include one or more polymer additives, rubber-based additives, acids, plasticizers, antistripping agents, and/or one or more other materials. By way of non-limiting example, the additives 220 may include one or more of styrene-butadiene-styrene (SBS), styrene-isoprene-styrene (SIS), ethylene vinyl acetate (EVA), polyethylene/polypropylene, ethylene acrylate copolymer, polyvinyl chloride (PVC), ethylene propylene, crumb rubber, devulcanized rubber (DVR), polyphosphoric acid (PPA), antioxidants (e.g., amine-based antioxidants, phenolic antioxidants, a sulfur-based antioxidant), waxes, an acrylic polyol resin, polyisocyanate, or other additives.

In some embodiments, the high viscosity vacuum tower bottoms material 204 exhibits a vacuum viscosity greater than about 50,000 P at about 60° C., such as greater than about 60,000 P, greater than about 100,000 P, greater than about 150,000 P, or greater than about 200,000 P at about 60° C. The high viscosity vacuum tower bottoms material 204 may exhibit a low temperature compliance within a range of from about −9° C. to about 0° C. A ΔT_{c} after 20 hours of PAV aging and 40 hours PAV aging of the high viscosity vacuum tower bottoms material 204 may be higher than about −5° C. The high viscosity vacuum tower bottoms material 204 may include, for example, from about 3.0 weight percent to about 5.0 weight percent saturates, from about 30.0 weight percent to about 45.0 weight percent aromatics, from about 29.0 weight percent to about 45.0 weight percent resins, and from about 21.0 weight percent to about 25.0 weight percent asphaltenes. In addition, the high viscosity vacuum tower bottoms material 204 may have a CII within a range of from about 0.30 to about 0.40. The high viscosity vacuum tower bottoms material 204 may be the same as the high viscosity vacuum tower bottoms material 150 described above with reference to FIG. 1.

The low viscosity vacuum tower bottoms material 208 may be the same as the low viscosity vacuum tower bottoms material 134. By way of non-limiting example, the low viscosity vacuum tower bottoms material 208 may have a vacuum viscosity within a range of 10 P to about 300 P at about 60° C. or within a range of from about 1 P to about 200 P at about 60° C., as described above. The low viscosity vacuum tower bottoms material 208 may include a bimodal distribution of C₆ to C₂₅ hydrocarbons and C₂₅ to C₃₅ hydrocarbons, as measured TE GC-MS. The C₆ to C₂₅ hydrocarbons may be aliphatic and may be in the diesel range, and the C₂₅ to C₃₅ hydrocarbons may be aliphatic and may be in the vacuum gas oil range. As measured by PY GC-MS, the low viscosity vacuum tower bottoms material 208 may include C₄ to C₂₃ hydrocarbons, such as a mixture of C₄ to C₂₃ olefinic and paraffinic hydrocarbons. In some embodiments, the low viscosity vacuum tower bottoms material 208 further includes up to C₂₉ paraffins. The mixture of C₄ to C₂₃ olefinic and paraffinic hydrocarbons may include pairs of olefinic and paraffinic C₄ to C₂₃ hydrocarbons.

The biomaterial 210 may include one or more materials formed from naturally-occurring materials, such as one or more materials formed from one or more vegetable oils and/or derived from one or more vegetable oils. In some embodiments, the biomaterial 210 includes at least 80.0 weight percent resin material, as determined by a SARA analysis. The biomaterial 210 may include a bio-resin. In some embodiments, the biomaterial 210 comprises a vegetable resin, such as a material including more than about 80.0 weight percent resins derived from one or more vegetable oils. A resin content of the biomaterial 210 may be at least about 80.0 weight percent, such as at least about 85.0 weight percent, at least about 90.0 weight percent, at least about 95.0 weight percent, at least about 97.0 weight percent, at least about 98.0 weight percent, at least about 99.0 weight percent, or at least about 99.5 weight percent resin. In some embodiments, resins constitute greater than about 90.0 weight percent of the biomaterial 210. In some embodiments, during a SARA analysis, more than about 80.0 weight percent of the biomaterial 210 is a resin. In other words, more than about 80.0 weight percent of the biomaterial 210 is soluble in a polar solvent, such as dichloromethane (DCM) or acetone.

In some embodiments, the biomaterial 210 includes at least some asphaltenes. Asphaltenes, if present in the biomaterial 210, may constitute from about 1.0 weight percent to about 20.0 weight percent of the biomaterial 210, such as from about 1.0 weight percent to about 2.0 weight percent, from about 2.0 weight percent to about 3.0 weight percent, from about 3.0 weight percent to about 4.0 weight percent, from about 4.0 weight percent to about 6.0 weight percent, from about 6.0 weight percent to about 8.0 weight percent, from about 8.0 weight percent to about 10.0 weight percent, or from about 10.0 weight percent to about 20.0 weight percent of the biomaterial 210. In some embodiments, asphaltenes constitute at least about 2.0 weight percent of the biomaterial 210, such as at least about 3.0 weight percent, at least about 5.0 weight percent, or at least about 7.0 weight percent of the biomaterial 210. In some embodiments, the biomaterial 210 comprises, consists essentially of, or consists of resins and asphaltenes. In some such embodiments, the biomaterial 210 is free of (e.g., substantially free of) saturates and aromatics.

The biomaterial 210 may include less than about 10.0 weight percent aromatics. Aromatics, if present in the biomaterial 210, may constitute from about 1.0 weight percent to about 10.0 weight percent of the biomaterial 210, such as from about 1.0 weight percent to about 5.0 weight percent, or from about 5.0 weight percent to about 10.0 weight percent of the biomaterial 210. The biomaterial 210 may include less than about 5.0 weight percent of saturates, such as less than about 4.0 weight percent, or less than about 2.5 weight percent saturates. Saturates, if present in the biomaterial 210, may constitute from about 0.10 weight percent to about 3.0 weight percent of the biomaterial 210, such as from about 0.10 weight percent to about 1.0 weight percent, from about 1.0 weight percent to about 2.0 weight percent, or from about 2.0 weight percent to about 3.0 weight percent of the biomaterial 210.

The biomaterial 210 may have a specific gravity within a range of from about 0.80 to about 0.90, such as from about 0.80 to about 0.82, from about 0.82 to about 0.84, from about 0.84 to about 0.86, from about 0.86 to about 0.88, or from about 0.88 to about 0.90. In some embodiments, the biomaterial 210 has a specific gravity within a range of from about 0.82 to about 0.86, such as from about 0.83 to about 0.85. A viscosity of the biomaterial 210 at about 64° C. may be within a range of from about 10 cP to about 1,000 cP, such as from about 10 cP to about 50 cP, from about 50 cP to about 100 cP, from about 100 cP to about 300 cP, from about 300 cP to about 500 cP, from about 500 cP to abou 750 cP, or from about 750 cP to about 1,000 cP. In some embodiments, the viscosity of the biomaterial 210 at about 64° C. is within a range of from about 10 cP to about 900 cP. A boiling point of the biomaterial 210 may be higher than about 200° C.

In some embodiments, the biomaterial 210 includes an ester bottoms material including methyl esters. Ester bottoms may include a low value byproduct of vegetable oil, animal fat, and/or recycled greases refining to produce methyl ester, such as biodiesel. Ester bottoms materials currently have relatively low value and are currently marketed for animal feed, lubricants, or other industrial uses at a low price point. In some embodiments, the biomaterial 210 comprises, consists essentially of, or consists of the ester bottoms material.

As noted above, ester bottoms materials are formed as a by-product of biodiesel refining. For example, a feedstock containing vegetable oil and/or animal fat is reacted and refined. By way of non-limiting example, the feedstock may be dried (e.g., in a dryer) to remove moisture therefrom and form dry oil. The dry oil may be fed to a reactor, such as a three-stage continuous reactor wherein a catalyst (e.g., sodium ethoxide) and methanol are added to each stage. The methanol reacts with the feedstock to form reaction products, which may include at least methyl ester and glycerin. In some embodiments, the reaction mixture including the reactants and the reaction products includes less than about 1.0 weight percent monoglycerides and is substantially free of diglycerides and triglycerides. The glycerin may be removed from the reaction mixture (e.g., may settle out of the reaction mixture) and may be directed away from the reactors for further processing. Removal of the glycerin from the reaction mixture may leave an ester phase.

The ester phase may be distilled (e.g., in a single stage flash distillation tank (or drum)) to remove any remaining methanol. The ester phase may be washed to remove at least some of the glycerin, soap, methanol, and methoxide catalyst. The washed methyl esters may dried in an ester dryer under vacuum to remove additional methanol and water. Sodium methoxide may be added to the drier to convert glycerin and monoglycerides into diglycerides and triglycerides. The methyl esters leaving the ester dryer may be preheated and provided to an ester surge tank. The esters may be fed to a distillation tower to separate purified methyl esters from ester bottoms. For example, the purified methyl esters may exit the top of the distillation tower and the ester bottoms may exit the bottom of the distillation tower.

The ester bottoms material may include one or more of (e.g., each of) methyl esters, sodium soap, monoglycerides, diglycerides, triglycerides, or unsaponifiable materials. Thus, the ester bottoms material may include methyl esters, monoglycerides, diglycerides, triglycerides, sodium soaps produced from the addition of sodium methoxide (a catalyst in the biodiesel refining process), and unsaponifiable materials. The ester bottoms material may not be or contain glycerin or skimmed fatty acids. In some embodiments, unsaponifiable materials constitute up to about 10.0 weight percent of the ester bottoms material. In some embodiments, the unsaponifiable materials constitute at least 10.0 weight percent of the ester bottoms material. In some embodiments, the unsaponifiable materials constitute at least about 2.0 weight percent, such as at least about 4.0 weight percent, at least about 6.0 weight percent, at least about 8.0 weight percent, or even at least about 10.0 weight percent of the ester bottoms material. In some embodiments, the ester bottoms material exhibits a viscosity within a range of from about 10 cP to about 900 cP at about 64° C.

The ester bottoms material may include methyl esters, monoglycerides, diglycerides, and triglycerides. By way of non-limiting example, a methyl ester content of the ester bottoms material may be within a range of from about 5.0 weight percent to about 20.0 weight percent, such as from about 5.0 weight percent to about 10.0 weight percent, from about 10.0 weight percent to about 15.0 weight percent, or from about 15.0 weight percent to about 20.0 weight percent. In some embodiments, the methyl ester content of the ester bottoms material is within a range of from about 9.0 weight percent to about 14.0 weight percent.

Accordingly, the biomaterial 210 may include an ester bottoms material comprising methyl esters, monoglycerides, diglycerides, and triglycerides. By way of non-limiting example, a methyl ester content of the ester bottoms material (and of the biomaterial 210) may be within a range of from about 5.0 weight percent to about 20.0 weight percent, such as from about 5.0 weight percent to about 10.0 weight percent, from about 10.0 weight percent to about 15.0 weight percent, or from about 15.0 weight percent to about 20.0 weight percent. In some embodiments, the methyl ester content of the ester bottoms material (and of the biomaterial 210) is within a range of from about 9.0 weight percent to about 14.0 weight percent. A monoglyceride content of the biomaterial 210 may be less than about 2.0 weight percent, such as less than about 1.0 weight percent, or less than about 0.75 weight percent. A diglyceride content of the ester bottoms material (and of the biomaterial 210) may be within a range of from about 5.0 weight percent to about 15.0 weight percent, such as from about 5.0 weight percent to about 7.0 weight percent, from about 7.0 weight percent to about 9.0 weight percent, from about 9.0 weight percent to about 11.0 weight percent, from about 11.0 weight percent to about 13.0 weight percent, or from about 13.0 weight percent to about 15.0 weight percent. In some embodiments, the diglyceride content of the ester bottoms material (and of the biomaterial 210) is within a range of from about 7.0 weight percent to about 11.0 weight percent. The diglyceride content of the ester bottoms material may be less than about 15.0 weight percent, such as less than about 13.0 weight percent, or less than about 11.0 weight percent of the ester bottoms material. A triglyceride content of the ester bottoms material (and of the biomaterial 210) maybe within a range of from about 37.0 weight percent 47.0 weight percent, such as from about 37.0 weight percent to about 39.0 weight percent, from about 39.0 weight percent to about 41.0 weight percent, from about 41.0 weight percent to about 43.0 weight percent, from about 43.0 weight percent to about 45.0 weight percent, or from about 45.0 weight percent to about 47.0 weight percent of the biomaterial 210. In some embodiments, the triglyceride content of the ester bottoms material is greater than about 40.0 weight percent and/or is within a range of from about 40.0 weight percent to about 43.0 weight percent.

A weight percent of either diglycerides or triglycerides in the ester bottoms material (and in the biomaterial 210) (in addition to the diglyceride content and the triglyceride content described above) may be within a range of 20.0 weight percent to about 30.0 weight percent, such as from about 20.0 weight percent to about 25.0 weight percent, or from about 25.0 weight percent to about 30.0 weight percent. A total fatty acid content of the ester bottoms material (and of the biomaterial 210) (not including the monoglycerides, diglycerides, triglycerides, or combination of diglycerides and triglycerides) may be less than about 5.0 weight percent, such as within a range of from about 1.0 weight percent to about 5.0 weight percent, such as from about 2.0 weight percent to about 4.0 weight percent.

An aromatic content of the ester bottoms material may be within a range of from about 5.0 weight percent to about 10.0 weight percent, such as from about 5.0 weight percent to about 7.0 weight percent, from about 7.0 weight percent to about 9.0 weight percent, or from about 9.0 weight percent to about 11.0 weight percent. In some embodiments, aromatics constitute from about 7.5 weight percent to about 8.5 weight percent of the ester bottoms material. A resin content of the ester bottoms material may be within a range of from about 85.0 weight percent to about 95.0 weight percent, such as from about 85.0 weight percent to about 87.5 weight percent, from about 87.5 weight percent to about 90.0 weight percent, from about 90.0 weight percent to about 92.5 weight percent, or from about 92.5 weight percent to about 95.0 weight percent. In some embodiments, resins constitute from about 91.5 weight percent to about 92.5 weight percent of the ester bottoms material. In some embodiments, the aromatic content of the ester bottoms material is greater than the aromatic content of the other biomaterials 210 described herein.

Table 1 below shows the composition of three different biomaterials, as measured by gas chromatography-mass spectrometry (GC-MS).

TABLE 1

| Component | Sample 1 | Sample 2 | Sample 3 |
|---|---|---|---|
| Total methyl ester | 12.853 | 9.113 | 13.322 |
| Total fatty acids | 2.901 | 2.376 | 2.906 |
| Total monoglycerides | 0.506 | 0.628 | 0.678 |
| Total diglycerides | 7.577 | 10.670 | 8.970 |
| Total triglycerides | 42.214 | 41.847 | 40.450 |
| Unknown between diglycerides | 22.958 | 24.001 | 21.677 |
| or triglycerides | | | |
| Other unknowns | 10.991 | 11.366 | 11.997 |

In some embodiments, the biomaterial 210 includes a bio-resin and includes a thermoplastic material. In some embodiments, the bio-resin is a resin derived from a renewable biological source material, such as plants, animals, algae, and microorganisms. In some embodiments, the biomaterial 210 is a polymer-based bio-resin. In some embodiments, the bio-resin includes a mixture of terpenes (e.g., one or more of alpha-pinene, beta-pinene, delta-3 carene, sabinene, limonene, terpinolene, sesquiterpenes, longifolene, caryophyllene, and delta-cadinene) and resin acids. In some embodiments, the biomaterial 210 includes alpha-pinene, beta-pinene, delta-3 carene monocyclic terpenes (e.g., limonene, terpinolene), sesquiterpenes (e.g., longifolene and caryophyllene), or combinations thereof. The biomaterial 210 may further include one or more rosin acids, such as one or more of abietic acid, pimaric acid, neoabietic acid, palustric acid, isopimaric acid, or combinations thereof.

In some embodiments, the biomaterial 210 includes a bio-resin that is formed from (e.g., derived from) one or bio-oils. The bio-oil may include one or more of vegetable oils, animal oils, or oil from algae (e.g., green algae (e.g., hallucinophyta, sea cucumber, parasites, hearing, beard hearing, jadebug, and salt weekly), brown algae (e.g., seaweed, kelp), red algae (e.g., red sea bream, red sea bream, red sea bream, red sea bream, red sea bream)). In some embodiments, the biomaterial 210 includes a bio-resin formed from one or more triglyceride-based vegetable oils. In some embodiments, the vegetable oil includes a triglyceride (which may be molecule comprising a reaction product of glycerol and three fatty acids, each of which fatty acids may be the same or different, and each of which fatty acids may be saturated or unsaturated). In some embodiments, the bio-oil is formed from biomass waste, such as by pyrolysis of biomass. In some embodiments, the bio-oil includes pyrolysis oil, which may be biomass-derived pyrolysis oil, municipal-waste derived pyrolysis oil, and/or pyrolysis oil formed from vegetable oils, animal fats, algae oil, or other biological material.

In some embodiments, the biomaterial 210 includes a bio-oil, such as vegetable oil, and/or the biomaterial 210 is derived from a vegetable oil. Non-limiting examples of vegetable oils include canola oil, safflower oil, flaxseed oil, cottonseed oil, peanut oil, almond oil, rice oil, linseed oil, rapeseed oil, jatropha oil, rubber seed oil, sunflower oil, soybean oil, olive oil, palm oil, castor coil, corn oil, grapeseed oil, jojoba oil, sesame oil, walnut oil, hazelnut oil, shea butter oil, macadamia oil, alfalfa oil, coconut oil, oiticica oil, poppyseed oil, soya oil, tung oil, algae oil, and wheat germ oil. In some embodiments, the biomaterial 210 includes bio-oil, such as animal oil and/or the biomaterial 210 is derived from animal oil. Non-limiting examples of animal oils include tallow oil (e.g., beef tallow oil), lard, or fish oil.

The algae oil may be formed from unicellular and/or multicellular algae. The algae oil may be formed from rhodophytes, chlorophytes, heterokontophytes, tribophytes, glaucophytes, chlorarachniophytes, euglenoids, haptophytes, cryptomonads, dinoflagellums, phytoplanktons, and combinations thereof. Non-limiting examples of species of algae include, for example, Neochloris oleoabundans, Scenedesmus dimorphus, Euglena gracilis, Phaeodactylum tricornutum, Pleurochrysis carterae, Prymnesium parvum, Tetraselmis chuff, and Chlamydomonas reinhardtii. Additional, non-limiting examples of algae species include one or more microalgae of the Achnanthes, Amphiprora, Amphora, Ankistrodesmus, Asteromonas, Boekelovia, Borodinella, Botryococcus, Bracteococcus, Chaetoceros, Carteria, Chlamydomonas, Chlorococcum, Chlorogonium, Chlorella, Chroomonas, Chrysosphaera, Cricosphaera, Crypthecodinium, Cryptomonas, Cyclotella, Dunaliella, Ellipsoidon, Emiliania, Eremosphaera, Ernodesmius, Euglena, Franceia, Fragilaria, Gloeothamnion, Haematococcus, Halocafeteria, Hymenomonas, Isochrysis, Lepocinclis, Micractinium, Monoraphidium, Nannochloris, Nannochloropsis, Navicula, Neochloris, Nephrochloris, Nephroselmis, Nitzschia, Ochromonas, Oedogonium, Oocystis, Ostreococcus, Pavlova, Parachlorella, Pascheria, Phaeodactylum, Phagus, Platymonas, Pleurochrysis, Pleurococcus, Prototheca, Pseudochlorella, Pyramimonas, Pyrobotrys, Scenedesmus, Skeletonema, Spyrogyra, Stichococcus, Tetraselmis, Thalassiosira, Viridiella, and Volvox species, and/or one or more cyanobacteria of the Agmenellum, Anabaena, Anabaenopsis, Anacystis, Aphanizomenon, Arthrospira, Asterocapsa, Borzia, Calothrix, Chamaesiphon, Chlorogloeopsi s, Chroococcidiopsi s, Chroococcus, Crinalium, Cyanobacterium, Cyanobium, Cyanocystis, Cyanospira, Cyanothece, Cylindrospermopsis, Cylindrospermum, Dactyl ococcopsis, Dermocarpella, Fischerella, Fremyella, Geitleria, Geitlerinema, Gloeobacter, Gloeocapsa, Gloeothece, Halospirulina, Iyengariella, Leptolyngbya, Limnothrix, Lyngbya, Microcoleus, Microcystis, Myxosarcina, Nodularia, Nostoc, Nostochopsis, Oscillatoria, Phormidium, Planktothrix, Pleurocapsa, Prochlorococcus, Prochloron, Prochlorothrix, Pseudanabaena, Rivularia, Schizothrix, Scytonema, Spirulina, Stanieria, Starria, Stigonema, Symploca, Synechococcus, Synechocystis, Tolypothrix, Trichodesmium, Tychonema, and Xenococcus species.

In some embodiments, biomaterial 210 includes a bio-oil including one or more fatty acids. For example, each of the vegetable oils, animal oils, and/or algae oils described above may include one or more fatty acids (e.g., may include monoglycerides, diglycerides, and/or triglycerides formed from one or more fatty acids). Accordingly, the biomaterial 210 formed from the bio-oils may include one or more corresponding fatty acids and/or comprise a reaction product of one or more fatty acids or materials containing the one or more fatty acids.

The fatty acids may be unsaturated fatty acids and one or more saturated fatty acids. The unsaturated fatty acids and the saturated fatty acids may be naturally occurring (e.g., derived from plants, such as from vegetable oils and/or algae oils; and/or derived from animal sources). The fatty acids may be linear, branched, or may include one or more cyclic groups. The unsaturated fatty acids may include a monounsaturated fatty acid having one carbon to carbon double bond; a di-unsaturated fatty acid having two carbon to carbon double bonds; a tri-unsaturated fatty acid having three carbon to carbon double bonds; a tetra-unsaturated fatty acid having four carbon to carbon double bonds; a penta-unsaturated fatty acid having five carbon to carbon double bonds; a hexa-unsaturated fatty acid having six carbon to carbon double bonds; or a polyunsaturated fatty acid having more than six carbon to carbon double bonds. In some embodiments, the wetting agent includes one or more monounsaturated fatty acids, one or more di-unsaturated fatty acids, and one or more tri-unsaturated fatty acids.

The unsaturated fatty acid may include one or more of linolenic acid (e.g., α-linolenic acid and/or γ-linolenic acid), stearidonic acid, eicosapentaenoic acid, cervonic acid, linoleic acid, linolelaidic acid, arachidonic acid, docosatetranoic acid, palmitoleic acid, vaccenic acid, paullinic acid, oleic acid, elaidic acid, erucic acid, crotonic acid, myristoleic acid, sapienic acid, gadoleic acid, or eicosenoic acid.

The saturated fatty acids may include one or more of valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, behenic acid, tricosylic acid, lignoceric acid, pentacosylic acid, cerotic acid, carboceric acid, montanic acid, nonacosylic acid, melissic acid, lacceroic acid, or psyllic acid. In some embodiments, the saturated fatty acids include C₁₆ and/or C₁₈ saturated fatty acids. For example, the saturated fatty acids may include one or both of palmitic acid and stearic acid. In some embodiments, the saturated fatty acids include C₁₂ fatty acids, such as lauric acid. In some embodiments, the saturated fatty acids include linear saturated fatty acids and may be naturally occurring, such as saturated fatty acids sourced from plants (e.g., vegetable oils) and/or animals.

In some embodiments, the unsaturated fatty acid includes one or more unsaturated C₁₈ fatty acids, such as one or more of oleic acid, linoleic acid, linolelaidic acid, α-linolenic acid, γ-linolenic acid, or stearidonic acid. In some embodiments, the biomaterial 210 is formed from unsaturated fatty acids and/or material including unsaturated fatty acids including each of oleic acid, linoleic acid, and α-linolenic acid; and saturated fatty acids including one or both of stearic acid and palmitic acid. In some embodiments, the biomaterial 210 is formed from elaidic acid and/or materials including elaidic acid. In some embodiments, the fatty acids include one or more C₁₈ fatty acids, such as one or more of stearic acid, oleic acid, linoleic acid, and linolenic acid. In some embodiments, the fatty acids include palmitic acid and/or myristic acid.

Bio-resins formed from such bio-oils and/or materials including the fatty acids described above may include one or more of a phenolic resin, an epoxy resin, a polyester resin, an alkyd resin, and/or a polyurethane resin formed from the bio-oil. The phenolic resin, epoxy resin, polyester resin, alkyd resin, and polyurethane resin may include one or more fatty acids therein. For example, such resins may include a backbone including components of the fatty acids. By way of non-limiting example, a fatty acid may have the general formula R—COOH, wherein R is the base of the fatty acid (e.g., oleic acid may have the formula R—COOH, wherein R is CH₃(CH₂)₇CH═CH—(CH₂)₇—. In other words, the R group of the fatty acid may be incorporated in the biomaterial 210 and/or at least a portion of the R group of the fatty acid may be incorporated in the biomaterial 210.

In some embodiments, the bio-resin is formed from a bio-oil, such as a vegetable oil, animal oil, or a combination thereof. The bio-resins may include bio-resins formed from such bio-oils and may include phenolic resins, epoxy resins, polyester or alkyd resins, polyurethane resins, polyamine resins, or combinations thereof. In other words, the biomaterial may include a bio-oil-based phenolic resin, a bio-oil-based epoxy resin, a bio-oil-based polyester resin, a bio-oil-based alkyl resin, a bio-oil-based polyurethane resin, a bio-oil-based polyamine resin, or combinations thereof. The bio-oil may include one or more vegetable oils and the bio-oil based phenolic resin may include a vegetable-based phenolic resin; the bio-oil-based epoxy resin may include a vegetable-based epoxy resin; the bio-oil-based polyester may include a vegetable-based polyester; the bio-oil-based alkyl resin may include a vegetable-based alkyl resin; the bio-oil-based polyurethane resin may include a vegetable-based polyurethane resin; and the bio-oil-based polyamine resin may include a vegetable-based polyamine resin.

By way of non-limiting example, bio-oil-based phenolic resins may be formed by reacting phenols present in the bio-oil and/or in a pyrolysis oil derived from a biological material (e.g., biomass-derived pyrolysis oil, municipal-waste derived pyrolysis oil, and/or pyrolysis oil formed from vegetable oils, animal fats, algae oil, or other biological material), with an aldehyde (e.g., formaldehyde) to form phenol-aldehyde resins (e.g., phenol-formaldehyde resins). In some embodiments, the phenolic fraction of the bio-oil may be extracted from the bio-oil prior to reaction with the aldehyde. In some such embodiments, the biomaterial 210 includes a phenolic resin comprising a reaction product of the bio-oil and an aldehyde, such as formaldehyde. In some embodiments, the bio-oils are formed from or derived from pyrolysis of lignocellulosic materials. In some embodiments, vegetable oils may be thermally cracked or pyrolyzed to form phenol-containing materials that may be reacted with an aldehyde to form the phenolic resin. In some embodiments, the biomaterial 210 includes a bio-based phenolic resin comprising a reaction product of the pyrolysis oil derived from a biological material and an aldehyde. The reaction between the pyrolysis oil derived from the biological material and the aldehyde may be an aldol condensation reaction to form the bio-oil-based phenolic resins.

Epoxy-resins formed from bio-oil may be formed by epoxidizing the bio-oils, such as by reacting the bio-oil with one or more of epichlorohydrin, glycidol (epoxy alcohol), glycerol derivatives, propylene oxide, oxytane, ethylene oxide, diallyl carbonate, maleic anhydride, or other reactive agents to form an epoxidized bio-oil. In some embodiments, the bio-resin includes a reaction product of an epoxidized vegetable oil and a diamine, such as a diamine derived from one or more fatty acid dimers (e.g., fatty diamines). In some embodiments, the bio-oil includes an unsaturated bio-oil (e.g., one or more unsaturated fatty acids). The unsaturated bio-oil may be reacted with an oxidizing agent (e.g., hydrogen peroxide, epichlorohydrin) to epoxidize the bio-oil. The epoxidized bio-oil may be polymerized and/or cross-linked to form an epoxy-resin. The crosslinkers may include, for example, an anhydride (phthalic anhydride, maleic anhydride), an amine (e.g., ethylenediamine, diethylenetriamine), a polyol, and/or a phenolic compound. In some embodiments, the biomaterial 210 includes a reaction product of an epoxidized bio-oil and a crosslinker, such as one or more of an anhydride (phthalic anhydride, maleic anhydride), an amine (e.g., ethylenediamine, diethylenetriamine), a polyol, or a phenolic compound. Accordingly, in some embodiments, the biomaterial 210 comprises a bio-resin including one or more bio-oil-based epoxy-resins, which may be formed from one or more epoxidized bio-oils that have been polymerized and/or crosslinked. In some embodiments, the bio-resin includes a vegetable-based epoxy resin.

Polyester or alkyd resins may be formed by deriving fatty acids or esters from the bio-oils (e.g., through transesterification) and reacting with polyols (e.g., one or more of glycerol, pentaerythritol, or trimethylolpropane) and/or anhydrides (e.g., one or more of maleic anhydride, phthalic anhydride, isophthalic acid, glutaric anhydride, and/or succinic anhydride) to produce unsaturated polyester resins or alkyd resins. In some embodiments, the bio-oil and the polyol are mixed to form a mixture wherein the bio-oil is reacted with the polyol to at least partially esterify the bio-oil. The anhydrides may be added to the mixture, wherein the anhydrides react via condensation with the bio-oil and/or the polyol. Accordingly, the biomaterial 210 may include an alkyd resin comprising a reaction product of the bio-oil, a polyol, and an anhydride.

In some embodiments, the bio-oil may be reacted with a diol in a polycondensation reaction to form a polyester comprising a reaction product of the diol and the bio-oil. In some embodiments, the bio-oil is reacted with an alcohol (e.g., glycerol) to form a glyceride (e.g., monoglycerides, diglycerides), which is then reacted with an anhydride in a condensation reaction to form the alkyd resin. In some embodiments, the biomaterial 210 includes a vegetable-based polyester resin and/or a vegetable-based alkyd resin. In yet other embodiments, the polyester is formed via the fatty acid method, wherein the bio-oil is reacted with a polyhydric alcohol to form the polyester, wherein the polyester includes a backbone including the fatty acids of the bio-oil.

In some embodiments, the bio-oil or the biomaterial 210 do not include alkyd resins. In other words, the biomaterial 210 may be free of alkyd resins.

Polyurethane (PU) resins may be formed by hydroxylating bio-oils (such as by reacting the bio-oils with ethylene and/or diethylene glycol) to form a hydroxylated bio-oil; and reacting the hydroxylated bio-oil with isocyanates to produce bio-based polyurethanes. In some embodiments, the bio-oil is modified by epoxidation to form an epoxidized bio-oil, followed by hydroxylation to form polyols having a high hydroxyl number. The polyols may include polyols derived from bio-oils and may comprise a reaction product of an epoxidized bio-oil and one or both of water and an alcohol. The resulting polyols derived from the bio-oil is reacted with the isocyanate to form the bio-oil-based polyurethane resin. The isocyanate may include a diisocyanate, such as one or more of toluene diisocyanate, methylene diphenyl diisocyanate, naphthalene-1,5-diisocyanate, isophorone diisocyanate, hexamethylene diisocyanate, or methylene-4,4′-diphenyl diisocyanate. In some embodiments, the biomaterial 210 includes a vegetable-based polyurethane resin. In some embodiments, the biomaterial 210 includes a bio-oil-based polyurethane resin comprising a reaction product of a polyol derived from a bio-oil and an isocyanate.

The bio-oil-based polyamine resin may be formed by, for example, reacting a dimer acid with a diamine. In some embodiments, the bio-oil-based polyamine resin includes a reaction product of a dimer acid and a diamine. The diamine may include, for example, hexamethylene diamine. The dimer acid may be a dicarboxylic acid formed by the dimerization of an unsaturated fatty acid. In some embodiments, the dimer acid is formed by the condensation of oleic acid and includes C₃₆ dimer acid.

In some embodiments, the bio-oil-based polyamine resin includes a reaction product of an aminated oil and an epoxidized fatty acid and/or an epoxidized bio-oil. The aminated oil may include a reaction product of cysteamine chloride and one or both of a fatty diamine or a fatty amide. The fatty diamine or the fatty amide may include one or more of the fatty acids described above. In some embodiments, the bio-oil-based polyamine resin includes a reaction product of an epoxidized bio-oil and an amine. The amine may include, for example, one or more of ammonia, ethylenediamine, hexamethylenediamine, or other primary or secondary amines. In other embodiments, the bio-oil-based polyamine resin includes a reaction product of the bio-oil and an amine, which forms a bio-amide including amide bonds (e.g., R—COOH+NH2-R′→R—CONH—R′). The resulting bio-amide may be polymerized by reaction with an epoxide and/or an aldehyde (e.g., formaldehyde) and/or by polycondensation.

In some embodiments, the bio-resin includes a plant resin, such as one or more of amber resin, pine resin, Commiphora gileadensis (Balm of Gilead) resin, balsam, copal from trees of Protium copal and Hymenaea courbaril, dammar gum or dammar resin from trees of Dipterocarpaceae, resin from trees of plants of Calamus (Dracaena species) (also referred to as “dragon's blood”), elemi resin, olibanum (also referred to as frankincense) from Boswellia sacra, galbanum from Ferula gummosa, gum guaicum from the lignum vitae trees of Guaiacum genus, kauri gum from trees of Agathis australis, hashish (cannabis resin) from Cannabis indica, labdanum from a species of Cistus, mastic resin from the mastic tree Pistacia lentiscus, myrrh from shrubs of Commiphora, sandarac resin from Tetraclinis articulata, storax balsam, and spinifex resin.

In some embodiments, the biomaterial 210 includes at least two different biomaterials. For example, the biomaterial 210 may include a first material including a vegetable oil, plant oil, and/or a bio-resin derived from vegetable oil and/or animal oils; and a second material including an ester bottoms material. By way of non-limiting example, the biomaterial 210 may include a first material including at least 80.0 weight percent resin material, as determined by a SARA analysis; and a second material comprising the ester bottoms material.

The high viscosity vacuum tower bottoms material 204 may constitute at least about 30.0 weight percent of the cracking resistant asphalt binder 202, such as at least about 40.0 weight percent, at least about 50.0 weight percent, at least about 60.0 weight percent, at least about 70.0 weight percent, or even at least about 80.0 weight percent of the cracking resistant asphalt binder 202. The high viscosity vacuum tower bottoms material 204 may constitute from about 30.0 weight percent to about 85.0 weight percent of the cracking resistant asphalt binder 202, such as from about 30.0 weight percent to about 40.0 weight percent, from about 40.0 weight percent to about 50.0 weight percent, from about 50.0 weight percent to about 60.0 weight percent, from about 60.0 weight percent to about 65.0 weight percent, from about 65.0 weight percent to about 70.0 weight percent, from about 70.0 weight percent to about 75.0 weight percent, from about 75.0 weight percent to about 80.0 weight percent, or from about 80.0 weight percent to about 85.0 weight percent, or from about 90.0 weight percent of the cracking resistant asphalt binder 202. In some embodiments, the high viscosity vacuum tower bottoms material 204 constitutes from about 70.0 weight percent to about 80.0 weight percent of cracking resistant asphalt binder 202. In some embodiments, the high viscosity vacuum tower bottoms material constitutes greater than about (at least about) 60.0 weight percent, such as greater than about 70.0 weight percent of the cracking resistant asphalt binder 202.

The low viscosity vacuum tower bottoms material 208 may constitute from about 0.0 weight percent to about 20.0 weight percent of the cracking resistant asphalt binder 202, such as from about 0.0 weight percent to about 2.0 weight percent, from about 2.0 weight percent to about 5.0 weight percent, from about 5.0 weight percent to about 10.0 weight percent, from about 10.0 weight percent to about 12.0 weight percent, from about 12.0 weight percent to about 14.0 weight percent, from about 14.0 weight percent to about 16.0 weight percent, from about 16.0 weight percent to about 18.0 weight percent, or from about 18.0 weight percent to about 20.0 weight percent of the cracking resistant asphalt binder 202. The low viscosity vacuum tower bottoms material 208 may constitute from about 10.0 weight percent to about 20.0 weight percent of the cracking resistant asphalt binder 202, such as from about 15.0 weight percent to about 20.0 weight percent of the cracking resistant asphalt binder 202. The low viscosity vacuum tower bottoms material 208 may constitute greater than about 10.0 weight percent of the cracking resistant asphalt binder 202, such as greater than about 12.0 weight percent, greater than about 14.0 weight percent, greater than about 16.0 weight percent, or greater than about 18.0 weight percent. In some embodiments, the low viscosity vacuum tower bottoms material 208 constitutes greater than about 15.0 weight percent of the cracking resistant asphalt binder.

The biomaterial 210 may constitute from about 0.50 weight percent to about 20.0 weight percent of the cracking resistant asphalt binder 202, such as from about 0.50 weight percent to about 1.0 weight percent, from about 1.0 weight percent to about 2.0 weight percent, from about 2.0 weight percent to about 4.0 weight percent, from about 4.0 weight percent to about 6.0 weight percent, from about 6.0 weight percent to about 8.0 weight percent, from about 8.0 weight percent to about 10.0 weight percent, from about 10.0 weight percent to about 12.0 weight percent, from about 12.0 weight percent to about 15.0 weight percent, or from about 15.0 weight percent to about 20.0 weight percent of the cracking resistant asphalt binder 202. In some embodiments, the biomaterial 210 constitutes from about 0.50 weight percent to about 10.0 weight percent of the cracking resistant asphalt binder 202, such as from about 5.0 weight percent to about 10.0 weight percent of the cracking resistant asphalt binder 202. The biomaterial 210 may constitute greater than about 2.0 weight percent, such as greater than about 4.0 weight percent, greater than about 6.0 weight percent, greater than about 8.0 weight percent, greater than about 10.0 weight percent, or even greater than about 12.0 weight percent of the cracking resistant asphalt binder 202. In some embodiments, the biomaterial 210 constitutes greater than about 5.0 weight percent of the cracking resistant asphalt binder 202, such as greater than about 6.0 weight percent, greater than about 8.0 weight percent, greater than about 10.0 weight percent, or greater than about 12.0 weight percent of the cracking resistant asphalt binder 202.

In embodiments where the biomaterial 210 includes a first biomaterial and a second biomaterial, each of the first biomaterial and the second biomaterial may be present in a weight percent of from about 0.50 weight percent to about 20.0 weight percent of the cracking resistant asphalt binder 202; or the combined weight percent of the first biomaterial and the second biomaterial may be within a range of from about 0.50 weight percent to about 20.0 weight percent. In some embodiments, the biomaterial 210 includes the first biomaterial and the second biomaterial and includes a greater weight percent of the ester bottoms material than of the other biomaterial. In some embodiments, each of a first biomaterial and a second biomaterial individually constitutes from about 0.50 weight percent to about 10.0 weight percent of the cracking resistant asphalt binder 202.

The heavy vacuum gas oil 212, if present in the cracking resistant asphalt binder 202, may constitute from about 1.0 weight percent to about 30.0 weight percent of the cracking resistant asphalt binder 202, such as from about 1.0 weight percent to about 10.0 weight percent, from about 10.0 weight percent to about 20.0 weight percent, or from about 20.0 weight percent to about 30.0 weight percent of the cracking resistant asphalt binder 202. The medium vacuum gas oil 214 and the deasphalted oil 218, if present in the cracking resistant asphalt binder 202, may individually constitute from about 0.1 weight percent to about 10.0 weight percent of the cracking resistant asphalt binder 202, such as from about 0.1 weight percent to about 5.0 weight percent, or from about 5.0 weight percent to about 10.0 weight percent of the cracking resistant asphalt binder 202. The hard asphalt 216, if present in the cracking resistant asphalt binder 202, may constitute from about 0.0 weight percent to about 10.0 weight percent of the cracking resistant asphalt binder 202, such as from about 0.0 weight percent to about 1.0 weight percent, from about 1.0 weight percent to about 3.0 weight percent, from about 3.0 weight percent to about 5.0 weight percent, or from about 5.0 weight percent to about 10.0 weight percent of the cracking resistant asphalt binder 202. The additives 220, if present in the cracking resistant asphalt binder 202, may constitute from about 0.1 weight percent to about 20.0 weight percent of the cracking resistant asphalt binder 202, such as from about 0.1 weight percent to about 1.0 weight percent, from about 1.0 weight percent to about 5.0 weight percent, from about 5.0 weight percent to about 10.0 weight percent, from about 10.0 weight percent to about 15.0 weight percent, or from about 15.0 weight percent to about 20.0 weight percent of the cracking resistant asphalt binder 202.

The hybrid blend 206 may constitute from about 5.0 weight percent to about 70.0 weight percent (e.g., from about 20.0 weight percent to about 70.0 weight percent) of the cracking resistant asphalt binder 202, such as from about 5.0 weight percent to about 7.0 weight percent, from about 7.0 weight percent to about 10.0 weight percent, from about 10.0 weight percent to about 15.0 weight percent, from about 15.0 weight percent to about 20.0 weight percent, from about 20.0 weight percent to about 25.0 weight percent, from about 25.0 weight percent to about 30.0 weight percent, from about 30.0 weight percent to about 40.0 weight percent, from about 40.0 weight percent to about 50.0 weight percent, from about 50.0 weight percent to about 60.0 weight percent, or from about 60.0 weight percent to about 70.0 weight percent of the cracking resistant asphalt binder 202. In some embodiments, the hybrid blend 206 constitutes from about 20.0 weight percent to about 30.0 weight percent of the cracking resistant asphalt binder 202, such as from about 20.0 weight percent to about 25.0 weight percent of the cracking resistant asphalt binder 202.

In some embodiments, a weight ratio of the low viscosity vacuum tower bottoms material 208 to the biomaterial 210 in the hybrid blend 206 is within a range of from about 1.0:1.0 to about 10.0:1.0, such as from about 1.0:1.0 to about 2.0:1.0, from about 2.0:1.0 to about 3.0:1.0, from about 3.0:1.0 to about 4.0:1.0, from about 4.0:1.0 to about 5.0:1.0, from about 5.0:1.0 to about 7.0:1.0, or from about 7.0:1.0 to about 10.0:1.0. In other words, for every about 1.0 part by weight of the biomaterial 210 in the hybrid blend 206, the hybrid blend 206 may include from about 1.0 part by weight to about 10.0 parts by weight of the low viscosity vacuum tower bottoms material 208. In some embodiments, a weight ratio of the low viscosity vacuum tower bottoms material 208 to the biomaterial 210 in the hybrid blend 206 is within a range of from about 3.0:1.0 to about 4.0:1.0.

The cracking resistant asphalt binder 202 including the high viscosity vacuum tower bottoms material 204 and the hybrid blend 206 comprising the low viscosity vacuum tower bottoms material 208 and the biomaterial 210 may exhibit one or more desirable properties. The cracking resistant asphalt binder 202 may have a performance grade of PG 64-22 or a performance grade of PG 58-28. The high temperature compliance of the cracking resistant asphalt binder 202 may be at least about 60.0° C., such as at least about 62.0° C., at least about 64.0° C., at least about 66.0° C., at least about 68.0° C., or at least about 70.0° C. The high temperature compliance of the cracking resistant asphalt binder 202 may be within a range of from about 60.0° C. to about 70.0° C., such as from about 60.0° C. to about 62.0° C., from about 62.0° C. to about 64.0° C., from about 64.0° C. to about 66.0° C., from about 66.0° C. to about 68.0° C., or from about 68.0° C. to about 70.0° C. The low temperature compliance of the cracking resistant asphalt binder 202 may be lower than about −22° C., such as lower than about −22° C., lower than about −24° C., lower than about −26° C., lower than about −28° C., or lower than about −30° C. The low temperature compliance of the cracking resistant asphalt binder 202 may be within a range of from about −22° C. to about −30° C., such as from about −22° C. to about −24° C., from about −24° C. to about −26° C., from about −26° C. to about −28° C., or from about −28° C. to about −30° C.

Forming the cracking resistant asphalt binder 202 to include the high viscosity vacuum tower bottoms material 204 and the hybrid blend 206 comprising the low viscosity vacuum tower bottoms material 208 and the biomaterial 210 may increase (make less negative) the ΔT_{c} of the cracking resistant asphalt binder 202 after 40-hour PAV aging compared to asphalt binders not including the hybrid blend 206. The ΔT_{c} of the cracking resistant asphalt binder 202 after 40-hour PAV aging may be higher than about −5.0° C., such as higher than about −4.5° C., higher than about −4.0° C., higher than about −3.5° C., higher than about −3.0° C., higher than about −2.5° C., higher than about −2.0° C., or higher than about −1.5° C. The ΔT_{c} of the cracking resistant asphalt binder 202 after 40-hour PAV aging may be within a range of from about −5.0° C. to about −1.5° C., such as from about −5.0° C. to about −4.0° C., from about −4.0° C. to about −3.5° C., from about −3.5° C. to about −3.0° C., from about −3.0° C. to about −2.5° C., from about −2.5° C. to about −2.0° C., or from about −2.0° C. to about −1.5° C.

In some embodiments, the hybrid blend 206 facilitates forming a cracking resistant asphalt binder 202 from a base asphalt binder (e.g., the high viscosity vacuum tower bottoms material 204 and/or a straight asphalt) that does not pass a ΔT_{c} requirement of higher than −5° C. after 40-hour PAV aging. In some embodiments, the hybrid blend 206 may be provided to a performance grade PG 64-22 or PG 58-28 base asphalt binder (e.g., the high viscosity vacuum tower bottoms material 204 and/or a straight asphalt) having a ΔT_{c} lower than −5° C. to form a cracking resistant asphalt binder 202 having a ΔT_{c} higher than −5° C. and while still having a respective performance grade of PG 64-22 or PG 58-28.

In addition to improving the physical properties of the cracking resistant asphalt binder 202, the addition of the hybrid blend 206 comprising the low viscosity vacuum tower bottoms material 208 and the biomaterial 210 to the high viscosity vacuum tower bottoms material 204 to form the cracking resistant asphalt binder 202 improves the chemical properties of the cracking resistant asphalt binder 202. The colloidal instability index of the cracking resistant asphalt binder 202 may be less than about 0.50, such as less than about 0.45, less than about 0.40, less than about 0.38, less than about 0.36, or less than about 0.35. The colloidal instability index of the cracking resistant asphalt binder 202 may be within a range of from about 0.35 to about 0.45, such as from about 0.35 to about 0.37, from about 0.37 to about 0.39, from about 0.39 to about 0.41, from about 0.41 to about 0.43, or from about 0.43 to about 0.45.

The hybrid blend 206 including both of the low viscosity vacuum tower bottoms material 208 and the biomaterial 210 may exhibit synergistic properties in the cracking resistant asphalt binder 202. For example, the use of only low viscosity vacuum tower bottoms material 208 in the cracking resistant asphalt binder 202 (e.g., without the biomaterial 210) would be difficult to meet low temperature requirements of performance grade asphalt binders, such as an m-value higher than about 0.300. On the other hand, a cracking resistant asphalt binder 202 that includes only the biomaterial 210 and not the low viscosity vacuum tower bottoms material 208 may require higher quantities of the biomaterial 210 (e.g., higher than about 10.0 weight percent of the biomaterial 210), which would lead to potential challenges in high temperature properties, such as DSR and G/sin(δ) and may also create concerns with flash point, evaporation, and mass change. The hybrid blend 206 including the combination of the low viscosity vacuum tower bottoms material 208 and the biomaterial 210 facilitates forming the cracking resistant asphalt binder 202 to have desirable low temperature properties (e.g., m-value) and high temperature properties (e.g., DSR, G/sin(δ)) without creating safety and handling issues, such as low flash point. In addition, the hybrid blend 206 including the combination of the low viscosity vacuum tower bottoms material 208 and the biomaterial 210 improves the 40-hour ΔT_{c} of the cracking resistant asphalt binder 202 compared to asphalt binders that do not include the hybrid blend. The low viscosity vacuum tower bottoms material 208 and the biomaterial 210 may each soften the cracking resistant asphalt binder 202. The biomaterial 210 (such as an ester bottoms material) provides a desired phase angle (such as a phase angle higher than about 44°, such as higher than about 46°, higher than about 48°, or higher than about 50°) of the cracking resistant asphalt binder 202. While the biomaterial 210 increases the phase angle and softens the cracking resistant asphalt binder 202, too much of the biomaterial 210 may cause the cracking resistant asphalt binder 202 to fail mass change specifications (e.g., a maximum mass loss about 1.0 weight percent, per ASTM D1174; desirably a mass loss less than about 0.75 weight percent). Accordingly, the hybrid blend 206 of the low viscosity vacuum tower bottoms material 208 and the biomaterial 210 facilitates softening the cracking resistant asphalt binder 202 while allowing the cracking resistant asphalt binder 202 to pass mass change specifications.

The hybrid blend 206 in the cracking resistant asphalt binder 202 may increase the weight percent of resins and/or decrease the weight percent of aromatics in the cracking resistant asphalt binder 202 compared to asphalt binders formed with heavy vacuum gas oils and/or other softening materials. The resin content and the aromatics content of the cracking resistant asphalt binder 202 may be determined by IATROSCAN-SARA testing. Resins may constitute from about 25.0 weight percent to about 45.0 weight percent of the cracking resistant asphalt binder 202, such as from about 25.0 weight percent to about 30.0 weight percent, from about 30.0 weight percent to about 35.0 weight percent, from about 35.0 weight percent to about 40.0 weight percent, or from about 40.0 weight percent to about 45.0 weight percent of the cracking resistant asphalt binder 202. The resin content of the cracking resistant asphalt binder 202 may be greater than about 25.0 weight percent, such as greater than about 27.0 weight percent, greater than about 30.0 weight percent, greater than about 32.0 weight percent, greater than about 35.0 weight percent, greater than about 37.0 weight percent, or greater than about 40.0 weight percent.

Aromatics may constitute from about from about 25.0 weight percent to about 45.0 weight percent of the cracking resistant asphalt binder 202, such as from about 25.0 weight percent to about 30.0 weight percent, from about 30.0 weight percent to about 35.0 weight percent, from about 35.0 weight percent to about 40.0 weight percent, or from about 40.0 weight percent to about 45.0 weight percent of the cracking resistant asphalt binder 202. Aromatics may constitute less than about 45.0 weight percent of the cracking resistant asphalt binder 202, such as less than about 40.0 weight percent, less than about 38.0 weight percent, less than about 35.0 weight percent, less than about 33.0 weight percent, or less than about 30.0 weight percent of the cracking resistant asphalt binder 202. In some embodiments, the cracking resistant asphalt binder 202 includes less than about 40.0 weight percent aromatics and greater than about 30.0 weight percent resins, such as greater than about 35.0 weight percent resins.

In some embodiments, the cracking resistant asphalt binder 202 is a performance grade PG 64-22 asphalt binder and has a high temperature compliance greater than about 68° C. and a low temperature compliance lower than about −24° C.; a ΔT_{c} after 40 hours PAV aging within a range of from about −4.5° C. to about −2.5° C. (e.g., a 40-hour ΔT_{c} less than about −4.0° C. or less than about −3.5° C.; a 40-hour ΔT_{c} of about −3.2° C.); a colloidal instability index less than about 0.40, such as within a range of from about 0.33 to about 0.40 (e.g., a CII lower than about 0.40, such as lower than about 0.37; a CII of about 0.35); a resin content greater than about 30.0 weight percent, such as a resin content within a range of from about 32.0 weight percent to about 38.0 weight percent (a resin content greater than about 30.0 weight percent, such as greater than about 32.0 weight percent; a resin content of about 35.2 weight percent); and an aromatic content within a range of from about 35.0 weight percent to about 42.0 weight percent (an aromatic content less than about 40.0 weight percent; an aromatic content of about 38.6 weight percent). Such cracking resistant asphalt binders 202 may include from about 11.0 weight percent to about 21.0 weight percent of the low viscosity vacuum tower bottoms material 208, such as from about 13.0 weight percent to about 19.0 weight percent, or from about 15.0 weight percent to about 17.0 weight percent of the low viscosity vacuum tower bottoms material 208 (e.g., about 16.0 weight percent of the low viscosity vacuum tower bottoms material 208); and from about 2.0 weight percent to about 10.0 weight percent of the biomaterial 210, such as from about 2.0 weight percent to about 8.0 weight percent, or from about 4.0 weight percent to about 6.0 weight percent of the biomaterial 210 (e.g., about 5.0 weight percent of the biomaterial 210).

In some embodiments, the cracking resistant asphalt binder 202 is a performance grade PG 58-28 asphalt binder and has a high temperature compliance greater than about 60° C. and a low temperature compliance lower than about −28° C.; a ΔT_{c} after 40 hours PAV aging within a range of from about −5.0° C. to about −2.5° C. (e.g., a 40-hour ΔT_{c} less than about −4.0° C., less than about −3.5° C., less than about −3.0° C., or less than about −2.5° C.; a 40-hour ΔT_{c} of about −2.2° C.); a colloidal instability index within a range of from about 0.38 to about 0.41 (e.g., a CII of about 0.40 or lower; a CII of about 0.40); a resin content greater than about 30.0 weight percent, such as a resin content within a range of from about 32.0 weight percent to about 38.0 weight percent (a resin content greater than about 30.0 weight percent, such as greater than about 32.0 weight percent; a resin content of about 36.0 weight percent); and an aromatic content within a range of from about 32.0 weight percent to about 40.0 weight percent (an aromatic content less than about 40.0 weight percent; an aromatic content of about 35.5 weight percent). Such cracking resistant asphalt binders 202 may include from about 13.0 weight percent to about 23.0 weight percent of the low viscosity vacuum tower bottoms material 208, such as from about 15.0 weight percent to about 21.0 weight percent, or from about 17.0 weight percent to about 19.0 weight percent of the low viscosity vacuum tower bottoms material 208 (e.g., about 18.0 weight percent of the low viscosity vacuum tower bottoms material 208); and from about 4.0 weight percent to about 12.0 weight percent of the biomaterial 210, such as from about 4.0 weight percent to about 10.0 weight percent, or from about 6.0 weight percent to about 8.0 weight percent of the biomaterial 210 (e.g., about 7.0 weight percent of the biomaterial 210).

FIG. 3 is a simplified flow diagram illustrating a method 300 of forming a cracking resistant asphalt binder, according to at least one embodiment of the disclosure. The method 300 may include forming a high viscosity vacuum tower bottoms material, as shown in act 302. The high viscosity vacuum tower bottoms material may be substantially the same as the high viscosity vacuum tower bottoms material 150 described above with reference to FIG. 1. In some embodiments, the high viscosity vacuum tower bottoms material 150 has a vacuum viscosity greater than about 50,000 P at about 60° C., such as greater than about 60,000 P, greater than about 100,000 P, greater than about 150,000 P, or greater than about 200,000 P at about 60° C.

The method 300 may further include mixing a low viscosity vacuum tower bottoms material with the high viscosity vacuum tower bottoms material to form a mixture, as shown in act 304. The low viscosity vacuum tower bottoms material may be the same as the low viscosity vacuum tower bottoms material 134 described above with reference to FIG. 1. By way of non-limiting example, the low viscosity vacuum tower bottoms material may have a vacuum viscosity within a range of 10 P to about 300 P at about 60° C. or within a range of from about 1 P to about 200 P at about 60° C.

The method 300 may further include mixing a biomaterial with the mixture to form a cracking resistant asphalt binder, as shown in act 306. The biomaterial may be substantially the same as the biomaterial 210 described above with reference to FIG. 2. In some embodiments, the cracking resistant asphalt binder includes from about 0.50 weight percent to about 20.0 weight percent of the biomaterial by weight of the cracking resistant asphalt binder.

While the method 300 has been described as including adding the low viscosity vacuum tower bottoms material to the high viscosity vacuum tower bottoms material before the biomaterial, the disclosure is not so limited. In other embodiments, the act 306 may be performed before act 304 and the biomaterial may be added to the high viscosity vacuum tower bottoms material to form a mixture prior to adding the low viscosity vacuum tower bottoms material to the high viscosity vacuum tower bottoms material. In addition, while the method 300 has been described as adding the low viscosity vacuum tower bottoms material and the biomaterial to the high viscosity vacuum tower bottoms material separately, the disclosure is not so limited. In some embodiments, the method includes forming a hybrid blend comprising the low viscosity vacuum tower bottoms material and the biomaterial and subsequently providing the hybrid blend to the high viscosity vacuum tower bottoms material to form the cracking resistant asphalt binder. The method 300 may further include adding one or more additional blend components (e.g., one or more of the heavy vacuum gas oil 212, the medium vacuum gas oil 214, the hard asphalt 216, the deasphalted oil 218, or the one or more additives 220) to the cracking resistant asphalt binder.

Forming the cracking resistant asphalt binder to include the hybrid blend of the low viscosity vacuum tower bottoms material and the biomaterial facilitates forming the cracking resistant asphalt binder to exhibit one or more of (e.g., each of) a performance grade (e.g., a performance grade of PG 58-28 or PG 64-22); a ΔT_{c} value greater than −5.0° C. after PAV aging for 40 hours; a ΔT_{c} value greater than −4.0° C. after PAV aging for 40 hours; a ΔT_{c} value greater than −3.0° C. after PAV aging for 40 hours; a colloidal instability index less than about 0.40, such as less than about 0.38; a resin content higher than about 30.0 weight percent, such as higher than about 35.0 weight percent; and an aromatic content less than about 40.0 weight percent. In addition, forming the cracking resistant asphalt binder from the low viscosity vacuum tower bottoms material and the biomaterial may facilitate forming a performance grade asphalt binder without using more valuable gas oils (e.g., heavy vacuum gas oil) as a softening blend component. Rather, the more valuable gas oils may be further processed, such as catalytically cracked and/or hydroprocessed, to form more valuable hydrocarbons. In some embodiments, the cracking resistant asphalt binder is a three component asphalt binder consisting of or consisting essentially of the high viscosity vacuum tower bottoms material, the low viscosity vacuum tower bottoms material, and the biomaterial and exhibits desirable properties, even though it does not include additional components (e.g., heavy vacuum gas oil) and/or additives such as polymers. Thus, forming the cracking resistant asphalt binder from the high viscosity vacuum tower bottoms material, the low viscosity vacuum tower bottoms material, and the biomaterial facilitates forming a cracking resistant asphalt binder having desirable properties with less expensive blend components and allows for more valuable components to be further processed, thereby increasing profits for the refinery.

### EXAMPLES

### Example 1

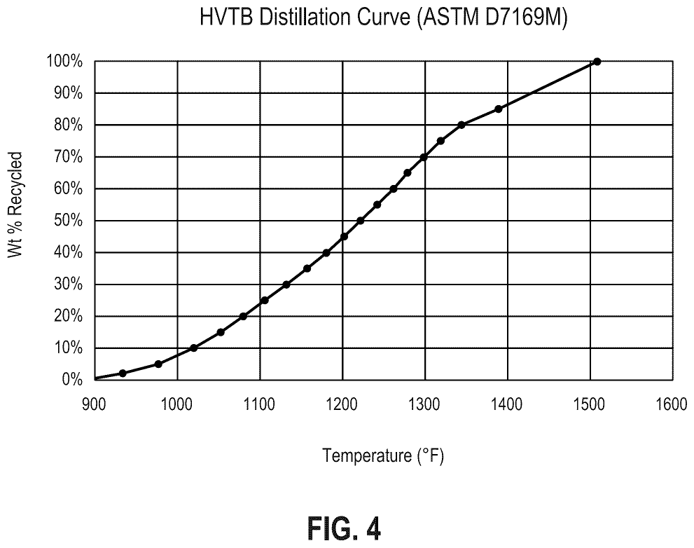

The distillation curve of a high viscosity vacuum tower bottoms material was measured according to the ASTM D7169M method. The weight percent of the high viscosity vacuum tower bottoms material that evaporated (was boiled off) as a function of temperature was measured. FIG. 4 is a graph illustrating the distillation curve of the high viscosity vacuum tower bottoms material. With reference to FIG. 4, the initial boiling point of the high viscosity vacuum tower bottoms material was about 482.2° C. (about 900° F.) and the end point of the high viscosity vacuum tower bottoms material was about 820° C. (about 1,508° F.).

### Example 2

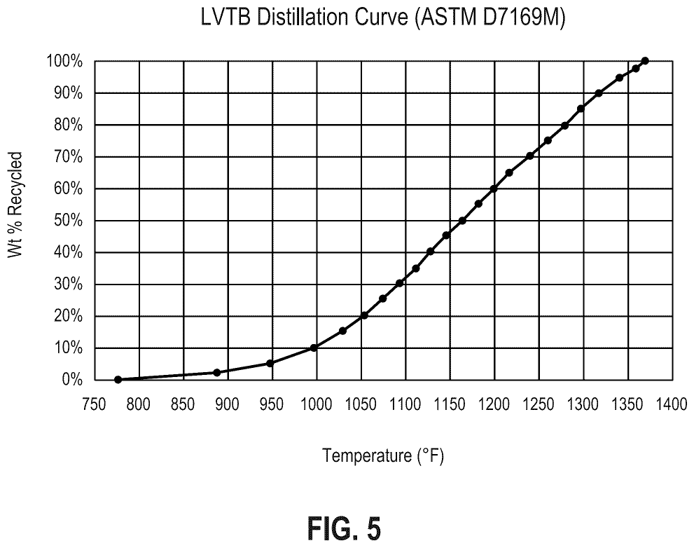

The distillation curve of a low viscosity vacuum tower bottoms material was measured according to the ASTM D7169M method. The weight percent of the low viscosity vacuum tower bottoms material that evaporated (was boiled off) as a function of temperature was measured. FIG. 5 is a graph illustrating the distillation curve of the low viscosity vacuum tower bottoms material. With reference to FIG. 5, the initial boiling point of low viscosity vacuum tower bottoms material was about 410° C. (about 770° F.) and the end point of the low viscosity vacuum tower bottoms material was about 740.6° C. (about 1,365° F.).

### Example 3

Performance grade asphalt binders formed from a high viscosity vacuum tower bottoms material, a low viscosity vacuum tower bottoms material, and a biomaterial were formed, and the properties of the performance grade asphalt binders was compared to control asphalt binders. A control asphalt binder (asphalt 1) having a performance grade of PG 64-22 was formed from about 79.0 weight percent high viscosity vacuum tower bottoms material and about 21.0 weight percent heavy vacuum gas oil was formed. A performance grade PG 64-22 asphalt binder (asphalt 2) was formed from about 79.0 weight percent high viscosity vacuum tower bottoms material, about 16.0 weight percent of a low viscosity vacuum tower bottoms material, and about 5.0 weight percent of a biomaterial to compare to asphalt 1. A control asphalt binder (asphalt 3) having a performance grade of PG 58-28 was formed from about 75.0 weight percent high viscosity vacuum tower bottoms material and about 25.0 weight percent heavy vacuum gas oil was formed. A performance grade PG 58-28 asphalt binder (asphalt 4) was formed from about 75.0 weight percent high viscosity vacuum tower bottoms material, about 18.0 weight percent of a low viscosity vacuum tower bottoms material, and about 7.0 weight percent of a biomaterial to compare to asphalt 3. The high viscosity vacuum tower bottoms material was the same as the high viscosity vacuum tower bottoms material of Example 1.

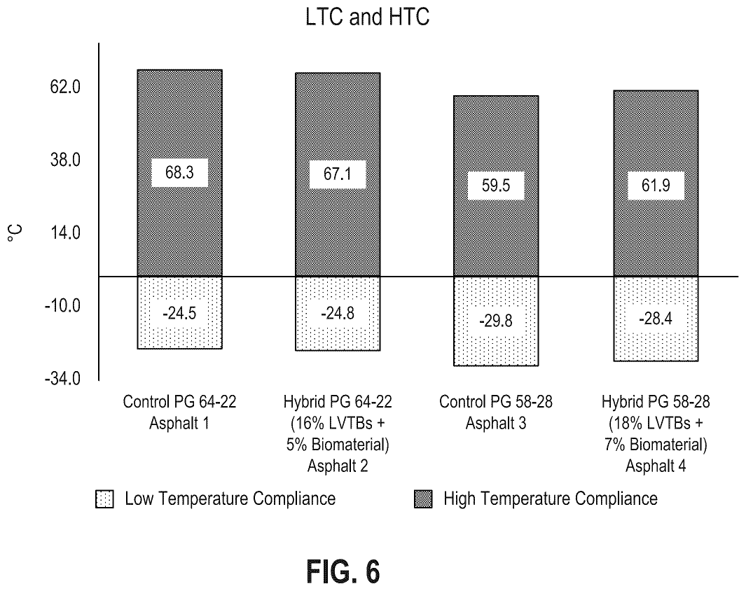

FIG. 6 is a graph illustrating the high temperature compliance and the low temperature compliance of the different asphalt binders. With reference to FIG. 6, the asphalt binders formed form the high viscosity vacuum tower bottoms material and the blend of low viscosity vacuum tower bottoms material and biomaterial exhibited a suitable high temperature compliance and low temperature compliance. The hybrid blend did not appear to substantially alter the high temperature compliance or the low temperature compliance compared to the control asphalt binders and the asphalt binders including the hybrid blend passed low temperature compliance and high temperature compliance requirements for performance grade asphalt binders (e.g., PG 64-22 and PG 58-28 asphalt binders).

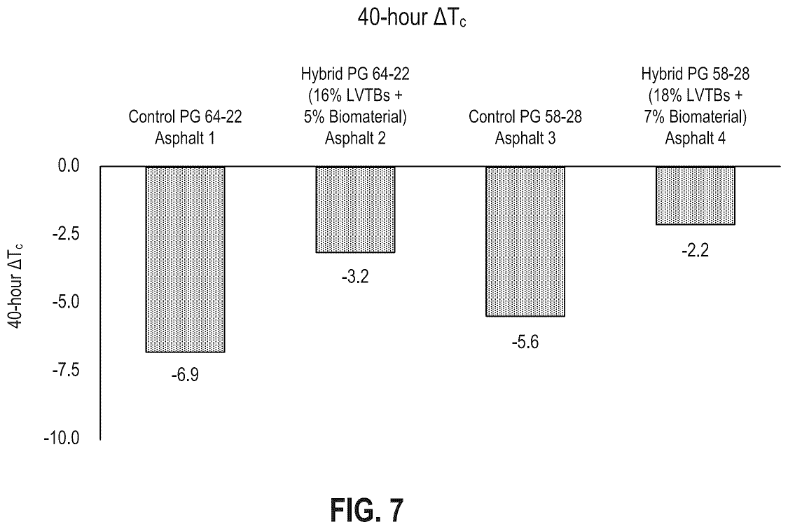

FIG. 7 is a graph illustrating the ΔT_{c} after 40-hour PAV aging of the asphalt binders. With reference to FIG. 7, the asphalt binders including the hybrid blend of the low viscosity vacuum tower bottoms material and the biomaterial passed temperature requirements for PG 64-22 and PG 58-28 asphalt, while the control asphalt binders did not. In particular, the asphalt binders including the hybrid blend had a ΔT_{c} after 40-hour PAV aging higher than −5.0° C., whereas the 40-hour PAV aged ΔT_{c} of the control asphalt binders was more negative than −5.0° C. and did not pass the low temperature requirements for the ΔT_{c}. Accordingly, the addition of the hybrid blend to the base asphalt binders improved the ΔT_{c} after 40-hour PAV aging higher of the base asphalt binders.

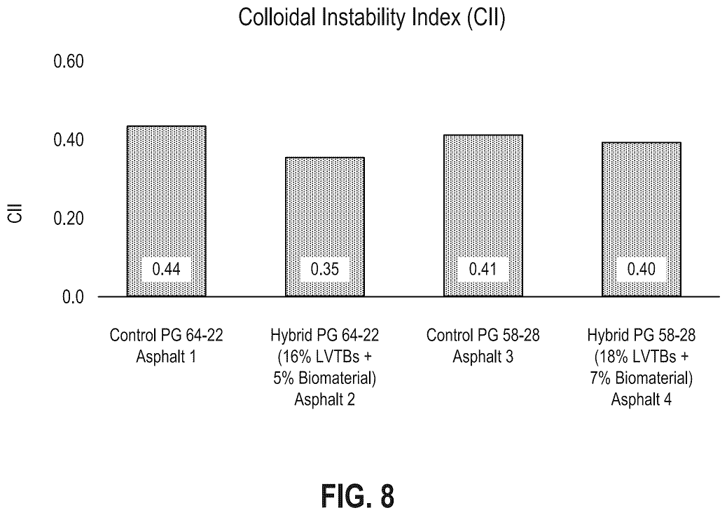

FIG. 8 is a graph illustrating the colloidal instability index of the asphalt binders. As shown in FIG. 8, the colloidal instability index of asphalt 2, the PG 64-22 asphalt binder including the hybrid blend had a substantially lower colloidal instability index than asphalt 1, the control PG 64-22 asphalt binder. The colloidal instability index of the PG 58-28 asphalt binders (asphalt 3 and asphalt 4) were relatively similar, but the colloidal instability index of the PG 58-28 asphalt binder with the hybrid blend was lower than the colloidal instability index of the control asphalt binder. Thus, the hybrid blend formed asphalt binders exhibiting the same or more stable asphalt binders compared to the control asphalt binders.

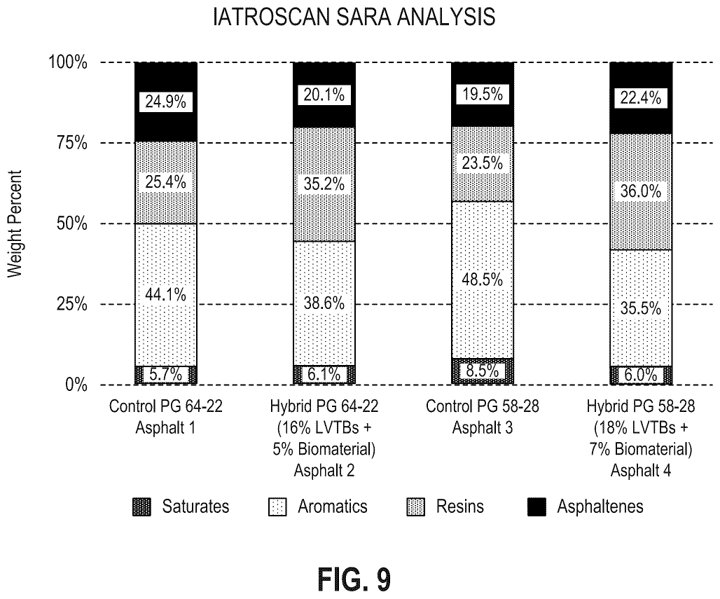

FIG. 9 is a graph illustrating the composition of the asphalt binders according to a SARA analysis. With reference to FIG. 9, forming the asphalt binders with the hybrid blend increased the resin content and decreased the aromatic content of the asphalt binders. The hybrid blend appeared to increase the resin content of the asphalt binders by about 10.0 weight percent or more.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A cracking resistant asphalt binder, comprising:
a high viscosity vacuum tower bottoms material having a vacuum viscosity greater than about 50,000 P at about 60° C.;
greater than about 10.0 weight percent of a low viscosity vacuum tower bottoms material; and
a biomaterial comprising greater than about 80.0 weight percent bio-resin.

2. The cracking resistant asphalt binder of claim 1, wherein the low viscosity vacuum tower bottoms material has a vacuum viscosity within a range of from about 10 P to about 300 P at about 60° C.

3. The cracking resistant asphalt binder of claim 1, wherein the high viscosity vacuum tower bottoms material constitutes at least about 70.0 weight percent of the cracking resistant asphalt binder.

4. The cracking resistant asphalt binder of claim 1, wherein the cracking resistant asphalt binder is substantially free of gas oil.

5. The cracking resistant asphalt binder of claim 1, wherein the cracking resistant asphalt binder consists essentially of or consists of the high viscosity vacuum tower bottoms material, the low viscosity vacuum tower bottoms material, and the biomaterial.

6. The cracking resistant asphalt binder of claim 1, wherein:
the low viscosity vacuum tower bottoms material constitutes from about 15.0 weight percent to about 20.0 weight percent of the cracking resistant asphalt binder; and
the biomaterial constitutes from about 5.0 weight percent to about 10.0 weight percent of the cracking resistant asphalt binder.

7. The cracking resistant asphalt binder of claim 1, wherein a weight ratio of the low viscosity vacuum tower bottoms material to the biomaterial is greater than about 3.0:1.0.

8. The cracking resistant asphalt binder of claim 1, wherein the cracking resistant asphalt binder exhibits a ΔT_{c} after aging in a pressure aging vessel for 40 hours higher than about −3.0° C.

9. The cracking resistant asphalt binder of claim 1, wherein the cracking resistant asphalt binder exhibits a colloidal instability index lower than about 0.38.

10. The cracking resistant asphalt binder of claim 1, wherein:
resins constitute greater than about 30.0 weight percent of the cracking resistant asphalt binder; and
aromatics constitute less than about 40.0 weight percent of the cracking resistant asphalt binder.

11. The cracking resistant asphalt binder of claim 1, wherein the cracking resistant asphalt binder is a performance grade PG 58-28 asphalt binder and exhibits:
a ΔT_{c} after 40 hours PAV aging within a range of from about −4.5° C. to about −2.5° C.;
a colloidal instability index less than about 0.40; and
a resin content greater than about 30.0 weight percent.

12. The cracking resistant asphalt binder of claim 1, wherein the biomaterial comprises one or more of:
phenolic resins, epoxy resins, polyester resins, polyurethane resins, or polyamine resins;
a polymerized or crosslinked epoxidized bio-oil;
a reaction product of a bio-oil, a polyol, and an aldehyde;
a reaction product of a dimer acid and a diamine or a reaction product of an epoxidized bio-oil and an amine; or
one or more C₁₈ fatty acids comprising at least one of oleic acid, linoleic acid, linolelaidic acid, α-linolenic acid, γ-linolenic acid, or stearidonic acid;
wherein the biomaterial is free of alkyd resins.

13. The cracking resistant asphalt binder of claim 1, wherein the biomaterial comprises an ester bottoms material.

14. A cracking resistant asphalt binder, comprising:
greater than about 60.0 weight percent of a high viscosity vacuum tower bottom material having a vacuum viscosity greater than about 50,000 P at about 60° C.;
from about 10.0 weight percent to about 20.0 weight percent of a low viscosity vacuum tower bottoms material having a vacuum viscosity less than about 300 P at about 60° C.; and
greater than about 5.0 weight percent of a biomaterial,
wherein the cracking resistant asphalt binder exhibits a ΔT_{c} after 40 hours PAV aging higher than about −4.0° C.

15. The cracking resistant asphalt binder of claim 14, wherein:
a resin content of the cracking resistant asphalt binder is greater than about 35.0 weight percent; and
an aromatic content of the cracking resistant asphalt material is less than about 40.0 weight percent.

16. A method of forming a cracking resistant asphalt binder, the method comprising:
providing a high viscosity vacuum tower bottoms material having a vacuum viscosity greater than about 50,000 P at about 60° C.; and
mixing a low viscosity vacuum tower bottoms material and a biomaterial with the high viscosity vacuum tower bottoms material to form a cracking resistant asphalt binder having a ΔT_{c} after 40-hour PAV aging higher than about −4.0° C.

17. The method of claim 16, wherein:
the low viscosity vacuum tower bottoms material has a vacuum viscosity less than about 300 P at about 60° C.;
the low viscosity vacuum tower bottoms material constitutes from about 10.0 weight percent to about 20.0 weight percent of the cracking resistant asphalt binder; and
the biomaterial constitutes from about 5.0 weight percent to about 10.0 weight percent of the cracking resistant asphalt binder.

18. The method of claim 16, wherein forming the cracking resistant asphalt binder comprises:
forming the cracking resistant asphalt binder to comprise greater than about 10.0 weight percent of the low viscosity vacuum tower bottoms material; and
forming the cracking resistant asphalt binder to comprise greater than about 5.0 weight percent of the biomaterial.

19. The method of claim 16, wherein forming the cracking resistant asphalt binder comprises forming the cracking resistant asphalt binder to comprise a resin content greater than about 30.0 weight percent and an aromatic content less than about 40.0 weight percent.

20. The method of claim 16, wherein a weight ratio of the low viscosity vacuum tower bottoms material to the biomaterial in the cracking resistant asphalt binder is within a range of from about 1.0:1.0 to about 10.0:1.0.
